(19) United States
(12) Patent Application Publication
(10) Pub. No.: US 2013/0037210 A1
(43) Pub. Date: Feb. 14, 2013

(54) PROCESS FOR PRODUCING FLEXOGRAPHIC PRINTING PLATE PRECURSOR FOR LASER ENGRAVING

(71) Applicant: Yuusuke KOZAWA, SHIZUOKA (JP)

(72) Inventor: Yuusuke KOZAWA, SHIZUOKA (JP)

(73) Assignee: FUJIFILM CORPORATION, Tokyo (JP)

(21) Appl. No.: 13/572,101

(22) Filed: Aug. 10, 2012

(30) Foreign Application Priority Data
Aug. 12, 2011 (JP) 2011-177228

(51) Int. Cl. C09J 5/06

(52) U.S. Cl. 156/306.9

(57) ABSTRACT

Disclosed are a process for producing a flexographic printing plate precursor for laser engraving, the method comprising, in the following order:
a thermally curable layer-forming step of forming a thermally curable layer containing (Component A) a polymerizable compound and (Component B) a thermal polymerization initiator; a laminating step of laminating an oxygen barrier film having an oxygen permeability at 25° C. and 1 atmosphere of 30 ml/(m²·day·atm) or less, on the thermally curable layer; and a thermally curing step of thermally curing the thermally curable layer, a flexographic printing plate precursor for laser engraving produced by the process; a process for making a flexographic printing plate; and a flexographic printing plate.

### TECHNICAL FIELD

The present invention relates to a process for producing a flexographic printing plate precursor for laser engraving.

### BACKGROUND ART

As a process for forming a printing plate by forming asperities in a photosensitive resin layer layered on a support surface area, a method in which a relief-forming layer formed using a photosensitive composition is exposed to UV light through an original image film to thus selectively cure an image area, and an uncured area is removed using a developer, the so-called ‘analogue plate making’, is well known.

A relief printing plate is a letterpress printing plate having a relief layer with asperities, and such a relief layer with asperities is obtained by patterning a relief-forming layer comprising a photosensitive composition containing as a main component, for example, an elastomeric polymer such as a synthetic rubber, a resin such as a thermoplastic resin, or a mixture of a resin and a plasticizer, thus forming asperities. Among such relief printing plates, one having a soft relief layer is sometimes called a flexographic printing plate.

When a relief printing plate is made by analogue plate making, since an original image film employing a silver salt material is generally necessary, production time and cost for the original image film are incurred. Furthermore, since development of the original image film requires a chemical treatment, and treatment of development effluent is required, simpler plate making methods, for example, a method that does not use an original image film, a method that does not require development processing, etc. have been examined.

In recent years, methods for carrying out plate-making of a relief-forming layer by scanning exposure without requiring an original image film have been investigated.

As a plate making process that does not require a development process, many of the so-called ‘direct engraving CTP methods’, in which a relief-forming layer is directly engraved by means of a laser, have been proposed. The direct engraving CTP method is a method in which relief-forming asperities are formed by engraving by means of the laser itself, and has the advantage that, unlike relief formation using an original image film, the relief shape can be freely controlled. Consequently, when such image as an outline character is to be formed, it is also possible to engrave that region deeper than other regions, or, in the case of a fine halftone dot image, it is possible, taking into consideration resistance to printing pressure, to engrave while adding a shoulder.

As a flexographic printing plate precursor having a cover film, those described in JP-A-2010-247527 (JP-A denotes a Japanese unexamined patent application publication), JP-A-2002-214792 or JP-A-2004-46057 are known.

### SUMMARY OF INVENTION

An object of the present invention is to provide a process for producing a flexographic printing plate precursor for laser engraving which is suppressed in terms of low rise of the relief surface, curling over time, and adhesion of contaminants, and which has excellent plate strength and excellent print performance.

Meanwhile, the term “low rise of the relief surface” means a phenomenon in which when the edge areas of a halftone dot relief melt, the height of the relief layer at the vertices of halftone dots is lowered than the height of the relief layer (height of solid areas) to be originally reproduced. The low rise affects the print density, and thus causes a problem in that the reproducibility of highlighted areas is insufficient.

The present invention was addressed by the means described in the following <1>, and <16> to <18>. They will be described below together with preferred exemplary embodiments <2> to <11>.

<1> A process for producing a flexographic printing plate precursor for laser engraving, the method including, in the following order:

a thermally curable layer-forming step of forming a thermally curable layer containing (Component A) a polymerizable compound and (Component B) a thermal polymerization initiator;

a laminating step of laminating an oxygen barrier film having an oxygen permeability at 25° C. and 1 atmosphere of 30 ml/(m2·day·atm) or less, on the thermally curable layer; and

a thermally curing step of thermally curing the thermally curable layer;

<2> the process for producing a flexographic printing plate precursor for laser engraving as described in <1>, wherein the oxygen barrier film is at least one selected from the group consisting of a polyester film, a nylon film, a polyethylene terephthalate film, a polyvinylidene chloride film, and a polyacrylonitrile film;

<3> the process for producing a flexographic printing plate precursor for laser engraving as described in <1> or <2>, wherein the thickness of the oxygen barrier film is 10 μm to 300 μm;

<4> the process for producing a flexographic printing plate precursor for laser engraving as described in any one of <1> to <3>, wherein (Component A) the polymerizable compound is a compound having two or more terminal ethylenically unsaturated bonds in one molecule; <5> the process for producing a flexographic printing plate precursor for laser engraving as described in any one of <1> to <4>, wherein the thermally curable layer contains (Component A) the polymerizable compound in an amount of 5 wt % to 30 wt % relative to the total solids content of the thermally curable layer;

<6> the process for producing a flexographic printing plate precursor for laser engraving as described in any one of <1> to <5>, wherein (Component B) is selected from the group consisting of organic peroxides and azo compounds;

<7> the process for producing a flexographic printing plate precursor for laser engraving as described in any one of <1> to <6>, wherein the thermally curable layer further contains (Component C) a photothermal conversion agent;

<8> the process for producing a flexographic printing plate precursor for laser engraving as described in <7>, wherein (Component C) the photothermal conversion agent is carbon black;

<9> the process for producing a flexographic printing plate precursor for laser engraving as described in any one of <1> to <8>, wherein the thermally curable layer further contains (Component D) a compound having a hydrolyzable silyl group and/or a silanol group;

<10> the process for producing a flexographic printing plate precursor for laser engraving as described in any one of <1> to <9>, wherein the thermally curable layer further contains (Component E) a binder polymer;

<11> the process for producing a flexographic printing plate precursor for laser engraving as described in <10>, wherein (Component E) the binder polymer is a non-elastomeric binder;

<12> the process for producing a flexographic printing plate precursor for laser engraving as described in <10> or <11>, wherein (Component E) the binder polymer is polyvinyl acetal or a derivative thereof;

<13> the process for producing a flexographic printing plate precursor for laser engraving as described in any one of <1> to <12>, further including a step of applying an adhesive on the reverse surface of a surface that is contact with the oxygen barrier film of the thermally curable layer, and bonding a support thereto;

<14> the process for producing a flexographic printing plate precursor for laser engraving as described in <13>, wherein the adhesive is a photocurable adhesive, and the thermally curable layer and the support are adhered by curing the photocurable adhesive by light;

<15> the process for producing a flexographic printing plate precursor for laser engraving as described in <13> or <14>, wherein the support is a transparent support;

<16> a flexographic printing plate precursor for laser engraving produced by the process for producing a flexographic printing plate precursor for laser engraving as described in any one of <1> to <15>;

<17> a process for making a flexographic printing plate, the process comprising, in the following order, the steps of: engraving a flexographic printing plate precursor for laser engraving as described in <16> by laser exposure; and removing the engraving residue generated by engraving using a rinsing liquid; and

<18> a flexographic printing plate made by the process for making a flexographic printing plate described in <17>.

### DESCRIPTION OF EMBODIMENTS

The process for producing a flexographic printing plate precursor for laser engraving (hereinafter, also simply referred to as “flexographic printing plate precursor” or “printing plate precursor”) includes, in the following order, a thermally curable layer forming step of forming a thermally curable layer comprising (Component A) a polymerizable compound and (Component B) a thermal polymerization initiator; a laminating step of laminating an oxygen barrier film having an oxygen permeability at 25° C. and 1 atmosphere of 30 ml/(m²·day·atm) or less; and a thermal curing step of thermally curing the thermally curable layer.

Meanwhile, in the present invention, the description of “the upper limit to the lower limit” denoting the numerical range denotes “not less than the lower limit but not more than the upper limit,” and “the upper limit to the lower limit” denotes “not more than the upper limit but not less than the lower limit.” That is, it denotes the numerical range that includes the upper and lower limits. Further, “(Component A) a polymerizable compound” etc. may be simply called “Component A” etc.

The inventor conducted a thorough investigation, and as a result, he found that in the production of a flexographic printing plate precursor for laser engraving which is constructed from a thermally curable composition containing a polymerizable compound and a thermal polymerization initiator, even if the thermally curable composition is cured in the thermal curable step, there are problems in that chemical reinforcement does not sufficiently proceed, the plate strength is decreased, deterioration of printing durability occurs, the elastic modulus at the drying temperature is low, the thermally curable composition is prone to “hot flow”, and the film thickness is unstabilized. Furthermore, the inventor found that since a large amount of unreacted polymerizable compound is present on the side of the surface that is in contact with air during the drying step (hereinafter, indicated as an oxygen barrier film side), when this unreacted polymerizable compound reacts over time, there occurs a difference in the shrinkage ratio between the surface that is not in contact with air, and the plate bends backward (hereinafter, indicated as curling), so that the storage properties of the plate is deteriorated. The inventor also found that there is a problem in that since a large amount of unreacted polymerizable compound is present, the oxygen barrier film side remains viscous, so that contaminants are likely to adhere, precision printing cannot be achieved, and liquid residue is scattered away at the time of laser engraving, thereby contaminating the engraving machine. The inventor also found that there is a problem in that if the engraved surface is excessively soft, the size of the halftone dots that are transferred to the print material changes due to the condition of the printing machine or the operation method of the user, and the print quality is unstabilized.

A flexographic printing plate for laser engraving is engraved when the polymer binder is thermally degraded by the heat generated at the time of laser irradiation. Furthermore, there is a concern that when the progress of the polymerization reaction at the oxygen barrier film side is insufficient, the elastic modulus at the plate temperature that reaches at the time of engraving is low, and the plate turns into a highly viscous liquid material, so that when high precision engraving is carried out by setting the laser irradiation interval to be narrow, thermal fusion of the edge areas occurs, a low-rise of the relief surface occurs, and high precision printing cannot be achieved.

The functional mechanism in the present invention is not clearly understood, but is speculated to be as follows.

It is known that in a photopolymerization reaction that occurs at a high speed of polymerization reaction, the radical generated from a polymerization initiator is deactivated when brought into contact with oxygen that is present in air, and the polymerizable compound is subjected to reaction inhibition (polymerization inhibition).

To date, polymerization inhibition due to oxygen has not been considered as a problem in the thermal polymerization reaction in which the reaction speed is moderate. However, in the thermal polymerization reaction, the inventor of the present invention found that the polymerizable compound does not undergo sufficient reaction on the oxygen barrier film surface side, and a large amount of unreacted polymerizable compound is present on the oxygen barrier film surface side. In the present invention, when an oxygen barrier film was laminated after a thermally curable composition was applied for the purpose of blocking oxygen, the contact between the radical generated from a polymerization initiator and oxygen present in air could be avoided, and the polymerizable compound could be made to sufficiently react even on the oxygen barrier film surface side. It is contemplated that thereby, a difference in the shrinkage ratio between the oxygen barrier film surface side and the support side was suppressed, curling could be reduced, and mechanical properties were reinforced, so that powderization of the engraving residue, a decrease in tackiness, and a suppression in the spread of halftone dots due to a change in the printing pressure could be realized.

Furthermore, in the case of applying an adhesive on the reverse surface of the surface that is in contact with the oxygen barrier film and bonding a support thereto, there have been occasions in which the adhesiveness between the adhesive layer and the printing plate is weak, and detachment occurs as a result of printing for a long time period. In the present invention, it was found that when an oxygen barrier film is laminated and thermally cured, such detachment between the support and the relief layer is suppressed. Although the functional mechanism is not clearly understood, it is speculated that previously when the polymerization initiator diffuses from the support surface side to the oxygen barrier film surface side, and deactivation of the radical occurs, so that the initiator concentration is decreased even on the support surface side, while the reaction ratio of the polymerizable compound is decreased even on the reverse surface (support surface) side. As such, it is contemplated that when an adhesive layer is applied on the support surface side of a printing plate precursor having a low reaction ratio of the polymerizable compound, there is a problem in that elution of a plasticizer and the like is not sufficiently suppressed by the crosslinked structure formed by polymerization, a plasticizer and the like are dissolved out to the adhesive layer, and the adhesive layer and the printing plate precursor are easily detached. It is speculated that when an oxygen barrier film is laminated, the polymerization reaction sufficiently proceeds over the entire plate, elution of a plasticizer is suppressed by a crosslinked structure that is densely formed, and detachment between the adhesive layer and the plate precursor does not easily occur.

Furthermore, when platemaking is carried out by a method of flow casting a coating liquid on a support, a decrease in the thickness of the edge areas occurs due to hot flow, so that when a printing plate is made, areas with small thicknesses need to be cut out, and it was a waste. However, it was found that when an oxygen barrier film is bonded, hot flow can be suppressed, and a decrease in the thickness of edge areas is suppressed. This is thought to be because hot flow of the thermally curable composition is avoided by the surface tension of the oxygen barrier film, but the cause is not clearly understood.

As discussed above, when a thermally curable composition is applied, and then an oxygen barrier film is laminated, curling over time, adhesion of contaminants, and the viscousness of the oxygen barrier film surface can be reduced, and a flexographic printing plate precursor for laser engraving having excellent plate strength can be produced. Meanwhile, JP-A-2010-247527, JP-A-2002-214792 and JP-A-2004-46057 disclose the use of a cover film, but do not disclose that the thermally curable layer is thermally cured after an oxygen barrier film is laminated. Further, the patent documents do not describe the problem occurring in relation to thermal curing.

In the following description, a thermally curable layer may also be called a relief-forming layer. According to the present invention, the flexographic printing plate precursor for laser engraving has a crosslinked relief-forming layer obtained by thermally curing a thermally curable layer (relief-forming layer). Furthermore, the thermally curable layer contains (Component A) a polymerizable compound and (Component B) a thermal polymerization initiator. According to the present invention, the thermally curable composition containing (Component A) a polymerizable compound and (Component B) a thermal polymerization initiator used for the formation of a thermally curable layer is also referred to as “a composition for laser engraving” or “a composition for laser engraving of the present invention”.

That is, the flexographic printing plate precursor for laser engraving of the present invention has a crosslinked relief-forming layer obtained by thermally crosslinking a thermally curable layer (relief-forming layer) formed by the composition for laser engraving of the present invention. Meanwhile, the “flexographic printing plate precursor for laser engraving” according to the present invention means a state in which a crosslinkable relief-forming layer comprising the composition for laser engraving has been cured by heat.

Hereinafter, the respective components constituting the thermally curable layer will be described in detail.

### (Component A) Polymerizable Compound

In the present invention, a thermally curable layer comprises (Component A) a polymerizable compound.

In the present invention, the polymerizable compound is preferably a compound having at least one ethylenically unsaturated bond (ethylenically unsaturated group), and more preferably a compound having at least two or more ethylenically unsaturated bonds. The polymerizable compound having at least one ethylenically unsaturated bond is preferable selected from compounds having at least one, preferably two or more terminal ethylenically unsaturated bonds. Examples of the group having a terminal ethylenically unsaturated bond preferably includes a (meth)acryloyl group, a viny group, etc. The compound having two or more (meth)acryloyl group in a molecule is preferable, that is, poly(meth)acrylate compound is preferable, and a poly(meth)acrylate compound having two or more acryloyl group in one molecule is more preferable.

Such a group of compounds is widely known in the present industrial field, and they may be used in the present invention without particular limitations. They have a chemical form such as, for example, a monomer, a prepolymer such as a dimer or a trimer, an oligomer, a mixture thereof, or a copolymer thereof.

Among them, the polymerizable compound is preferably a monomer, and a molecular weight (a number average molecular weight, when it has a molecular weight distribution) is preferably 50,000 or less, more preferably 50 to 10,000, and yet more preferably 100 to 2,000. When the molecular weight is in the above-mentioned range, the polymerize reation proceeds in a quick and efficient matter, the crosslinked structure is formed uniformly in the film, and the generation of the viscous engraving residue is suppressed. That is preferable.

Examples of the monomer and a copolymer thereof include unsaturated carboxylic acids (e.g. acrylic acid, methacrylic acid, itaconic acid, crotonic acid, isocrotonic acid, maleic acid, etc.), esters thereof, and amides thereof, and an ester of an unsaturated carboxylic acid and an aliphatic polyhydric alcohol compound or an amide of an unsaturated carboxylic acid and an aliphatic polyamine compound is preferably used. Furthermore, an addition reaction product of an unsaturated carboxylic acid ester or amide having a nucleophilic substituent such as a hydroxy group, an amino group, or a mercapto group with a monofunctional or polyfunctional isocyanate or epoxy, a dehydration-condensation reaction product between an unsaturated carboxylic acid ester or amide having the above nucleophilic substituent and a monofunctional or polyfunctional carboxylic acid, etc. may also be used suitably. Furthermore, an addition reaction product of an unsaturated carboxylic acid ester or amide having an electrophilic substituent such as an isocyanate group or an epoxy group with a monofunctional or polyfunctional alcohol, amine, or thiol, and a substitution reaction product of an unsaturated carboxylic acid ester or amide having a leaving substituent such as a halogen group or a tosyloxy group with a monofunctional or polyfunctional alcohol, amine, or thiol are also suitable. Furthermore, as other examples, a group of compounds in which the above-mentioned unsaturated carboxylic acid is replaced by an unsaturated phosphonic acid, styrene, vinyl ether, etc. may also be used.

Specific examples of ester monomers comprising an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl)ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include diethylene glycol dimethacrylate, tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethyl methane, bis[p-(methacryloxyethoxy)phenyl]dimethylmethane, and tricyclodecane dimethanol dimethacrylate.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

Examples of isocrotonic acid esters include ethylene glycol diisocrotonate, pentaerythritol diisocrotonate, and sorbitol tetraisocrotonate.

Examples of maleic acid esters include ethylene glycol dimaleate, triethylene glycol dimaleate, pentaerythritol dimaleate, and sorbitol tetramaleate.

As examples of other esters, aliphatic alcohol-based esters described in JP-B-46-27926 (JP-B denotes a Japanese examined patent application publication), JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used suitably.

The above-mentioned ester monomers may be used as a mixture.

Furthermore, specific examples of amide monomers including an amide of an aliphatic polyamine compound and an unsaturated carboxylic acid include N,N′-methylenebisacrylamide, N,N′-methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Preferred examples of other amide-based monomers include those having a cyclohexylene structure described in JP-B-54-21726.

Furthermore, a urethane-based polymerizable compound produced by an addition reaction of an isocyanate and a hydroxy group is also suitable, and specific examples thereof include a vinylurethane compound comprising two or more polymerizable vinyl groups per molecule in which a hydroxy group-containing vinyl monomer represented by Formula (I) below is added to a polyisocyanate compound having two or more isocyanate groups per molecule described in JP-B-48-41708.

CH₂═C(R)COOCH₂CH(R′)OH (I)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an polymerizable compound having an amino structure or a sulfide structure in the molecule described in JP-A-63-277653, JP-A-63-260909, and JP-A-1-105238, a composition for laser engraving having very good curing speed can be obtained.

Other examples include polyester acrylates such as those described in JP-A-48-64183, JP-B-49-43191, and JP-B-52-30490, and polyfunctional acrylates and methacrylates such as epoxy(meth)acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocurable monomers or oligomers in the Journal of the Adhesion Society of Japan, Vol. 20, No. 7, pp. 300 to 308 (1984) may also be used.

In view of the curing speed, a structure having a high content of unsaturated groups per one molecule is preferred, and in many cases, a structure having bifunctionality or higher functionality is preferred. Furthermore, in order to increase the strength of the image section, that is, the cured film, a structure having trifunctionality or higher functionality is preferred. Also, when compounds having different number of functionalities and different polymerizable groups (for example, acrylic acid ester, methacrylic acid ester, styrene-based compound, and vinyl ether-based compound) are used in combination, a method of adjusting both curability and strength is also effective.

The polymerizable compound is used in an amount in the range of preferably 2 wt % to 90 wt %, more preferably 5 wt % to 85 wt %, and even more preferably 5 wt % to 30 wt %, relative to the weight of the total solid fraction of the composition for laser engraving. Furthermore, these compounds may be used individually, or two or more kinds may be used in combination. Meanwhile, the total solid fraction of the composition for laser engraving means the components except for the solvent.

When the content of the polymerizable compound is in the range described above, it is preferable because a crosslinked structure is effectively formed, and high print quality can be obtained.

### (Component B) Thermal Polymerization Initiator

In the present invention, the thermally curable layer comprises (Component B) a thermal polymerization initiator.

As the thermal polymerization initiator, well-known examples among those known art may be used without particular limitations. Hereinafter, although the radical polymerization initiator which is a preferable thermal polymerization initiator will be described, the present invention is not limited by this description.

In the present invention, preferable radical polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (l) azo compounds. Hereinafter, although specific examples of the (a) to (l) are cited, the present invention is not limited to these.

In the present invention, when applies to the relief-forming layer of the flexographic printing plate precursor, from the viewpoint of engraving sensitivity and making a favorable relief edge shape, (c) organic peroxides and (l) azo compounds are more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (l) azo compounds preferably include the following compounds.

### (c) Organic Peroxides

Preferable (c) organic peroxides as a radical polymerization initiator that can be used in the present invention include preferably a peroxide ester such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate and t-butyl peroxybenzoate.

### (l) Azo Compounds

Preferable (l) azo compounds as a radical polymerization initiator that can be used in the present invention include those such as 2,2′-azobisisobutyronitrile, 2,2′-azobispropionitrile, 1,1′-azobis(cyclohexane-1-carbon itrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

With regard to the thermal polymerization initiator in the present invention, one type may be used on its own, or two or more types may be used in combination.

The content of the thermal polymerization initiator is preferably 0.001 to 15 wt % relative to the total solid content of the composition for laser engraving, and more preferably 0.002 to 10 wt %. When the content of the thermal polymerization initiator is at least 0.001 wt %, an effect from the addition thereof is obtained, and crosslinking of a crosslinkable relief-forming layer proceeds promptly. Furthermore, when the content is no greater than 15 wt %, other components do not become insufficient, and printing durability that is satisfactory as a relief printing plate is obtained.

### (Component C) Photothermal Conversion Agent

In the present invention, the thermally curable layer preferably further comprises (Component C) a photothermal conversion agent.

(Component C) the photothermal conversion agent preferably has a peak absorbing wavelength of 700 nm to 1,300 nm. In the present invention, when a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving to use Component C as an infrared absorbing agent. It is surmised that Component C absorbs laser light and generates heat thus promoting thermal decomposition of a cross-linked relief-forming layer of the printing plate precursor and improving sensitivity when laser engraving the printing plate precursor.

As Component C preferably has peak absorption at wavelength of 700 nm to 1,300 nm, various types of dye or pigment having such property are especially preferably used.

As the dyes, there can be used commercially available products or other known dyes disclosed in, for example, Senryo Binran (Dye Handbook), edited by The Society of Synthetic Organic Chemistry, Japan, published in 1970.

Specific examples thereof include azo dyes, metal complex salt azo dyes, pyrazolone azo dyes, naphthoquinone dyes, anthraquinone dyes, phthalocyanine dyes, carbonium dyes, diimonium compounds, quinonimine dyes, methine dyes, cyanine dyes, squarylium dyes, pyrylium salts, and metal thiolate complexes, and the like.

Preferable examples of the dyes include cyanine dyes disclosed in JP-A-58-125246, JP-A-59-84356, JP-A-59-202829, JP-A-60-78787 and the like; methine dyes disclosed in JP-A-58-173696, JP-A-58-181690, JP-A-58-194595 and the like; naphthoquinone dyes disclosed in JP-A-58-112793, JP-A-58-224793, JP-A-59-48187, JP-A-59-73996, JP-A-60-52940, JP-A-60-63744 and the like; squarylium dyes disclosed in JP-A-58-112792; and cyanine dyes disclosed in U.K. Patent No. 434,875 and the like.

Furthermore, near infrared ray absorption sensitizers disclosed in U.S. Pat. No. 5,156,938 may also be suitably used, and substituted arylbenzo(thio)pyrylium salts disclosed in U.S. Pat. No. 3,881,924, trimethine thiapyrylium salts disclosed in JP-A-57-142645 (U.S. Pat. No. 4,327,169), pyrylium type compounds disclosed in JP-A-58-181051, JP-A-58-220143, JP-A-59-41363, JP-A-59-84248, JP-A-59-84249, JP-A-59-146063 and JP-A-59-146061, cyanine dyes disclosed in JP-A-59-216146, pentamethine thiopyrylium salts disclosed in U.S. Pat. No. 4,283,475, and pyrylium compounds disclosed in JP-B-5-13514 and JP-B-5-19702 are preferably used. Other preferable examples of the dyes include near infrared ray absorption dyes represented by Formula (I) or (II) described in U.S. Pat. No. 4,756,993.

Also, other preferred examples of Component C used in the present invention include specific indolenine cyanine dyes described in JP-A-2002-278057.

Among these dyes, preferred are a cyanine dye, a squarylium dye, a pyrylium salt, a nickel thiolate complex and an indolenine cyanine dye, more preferred are a cyanine dye and an indolenine cyanine dye.

Specific examples of the cyanine dye which can be suitably used in the present invention include those described in JP-A-2001-133969 (paragraphs [0017] to [0019]), JP-A-2002-40638 (paragraphs [0012] to [0038]), and JP-A-2002-23360 (paragraphs [0012] to [0023]).

The dye represented by the following formula (d) or (e) is preferred in view of light-to-heat conversion.

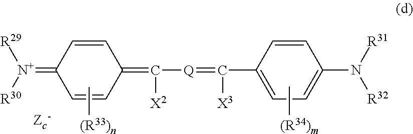

In formula (d), R²⁹ to R³² each independently represents a hydrogen atom, an alkyl group or an aryl group. R³³ and R³⁴ each independently represents an alkyl group, a substituted oxy group or a halogen atom. n and m each independently represents an integer of 0 to 4. The pair of R²⁹ and R³⁰ or the pair of R³¹ and R³² may combine with each other to form a ring. Also, R²⁹ and/or R³⁰ may combine with R³³ to form a ring, or R³¹ and/or R³² may combine with R³⁴ to form a ring. In the case where a plurality of R³³s or R³⁴s are present, R³³s or R³⁴s may combine with each other to form a ring. X² and X³ each independently represents a hydrogen atom, an alkyl group or an aryl group, provided that at least one of X² and X³ represents a hydrogen atom or an alkyl group. Q represents a trimethine group which may have a substituent or a pentamethine group which may have a substituent or may form a ring structure together with a divalent organic group. Zc⁻ represents a counter anion. However, Zc⁻ is not necessary when the coloring matter represented by formula (d) has an anionic substituent in its structure and neutralization of charge is not needed. In view of storage stability of the coating solution for the relief-forming layer, Zc⁻ is preferably a halogen ion, a perchlorate ion, a tetrafluoroborate ion, a hexafluorophosphate ion or a sulfonate ion, particularly preferably a perchlorate ion, a hexafluorophosphate ion or an arylsulfonate ion.

Specific examples of the dye represented by formula (d) which can be suitably used in the present invention include those shown below.

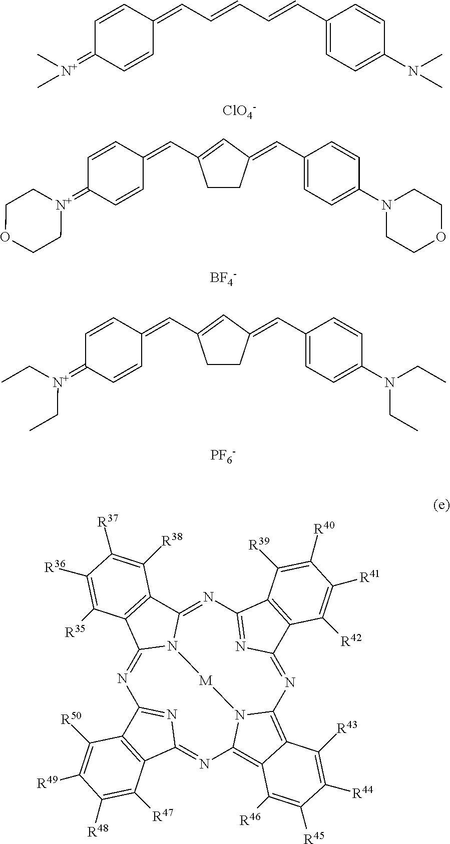

In formula (e), R³⁵ to R⁵⁰ each independently represents a hydrogen atom, a halogen atom, a cyano group, an alkyl group, an aryl group, an alkenyl group, an alkynyl group, a hydroxy group, a carbonyl group, a thio group, a sulfonyl group, a sulfinyl group, an oxy group, an amino group or an onium salt structure. These groups each may have a substituent when a substituent can be introduced thereinto. M represents two hydrogen atoms, a metal atom, a halometal group or an oxymetal group, and examples of the metal atom contained therein include atoms of Groups 1, 2, 13 and 14 of the periodic table, transition metals of first, second and third periods, and lanthanoid element. Among these, copper, magnesium, iron, zinc, cobalt, aluminum, titanium and vanadium are preferred.

Specific examples of the dye represented by formula (e) which can be suitably used in the present invention include those shown below.

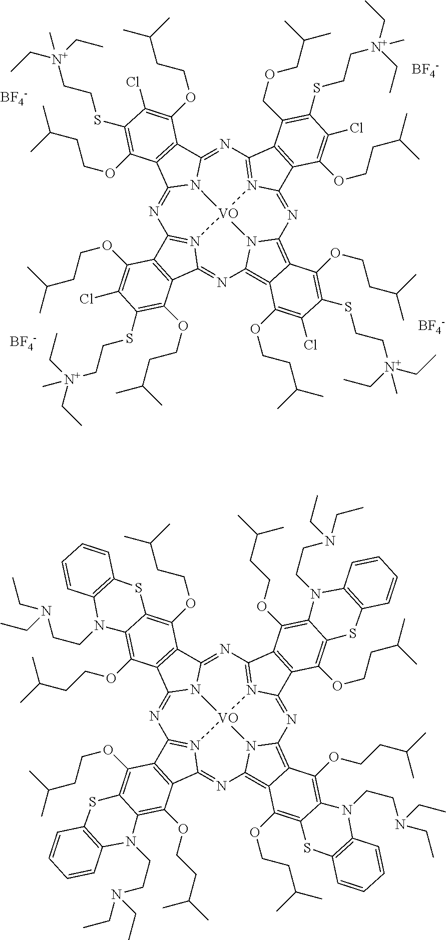

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984).

Examples of the type of pigment include a black pigment, a yellow pigment, an orange pigment, a brown pigment, a red pigment, a purple pigment, a blue pigment, a green pigment, a fluorescent pigment, a metal powder pigment and, in addition, polymer-binding dyes. Specifically, an insoluble azo pigment, an azo lake pigment, a condensed azo pigment, a chelate azo pigment, a phthalocyanine type pigment, an anthraquinone type pigment, perylene and perinone type pigments, a thioindigo type pigment, a quinacridone type pigment, a dioxazine type pigment, an isoindolinone type pigment, a quinophthalone type pigment, a dye lake pigment, an azine pigment, a nitroso pigment, a nitro pigment, a natural pigment, a fluorescent pigment, an inorganic pigment, carbon black, etc. may be used. Among these pigments, carbon black is preferable.

These pigments may be used with or without a surface treatment. The methods of the surface treatment include methods of coating a resin or wax onto the surface, applying a surfactant, binding a reactive substance (e.g., a silane coupling agent, epoxy compound, polyisocyanate, and the like) to the pigment surface, and the like. The above mentioned surface treatment methods are described in Kinzoku Sekken No Seishitsu To Ohyo (Properties and Applications of Metallic Soaps), published by Saiwai Shobo; Insatsu Inki Gijutsu (Printing Ink Technologies), published by CMC Publishing Co., Ltd. (1984); and Saishin Ganryo Ohyo Gijutsu (Current Pigment Application Technologies), published by CMC Publishing Co., Ltd. (1986).

Furthermore, when the photothermal conversion agent and the binder polymer are used in a combination (condition) such that the thermal degradation temperature of the photothermal conversion agent is equal to or higher than the thermal degradation temperature of the binder polymer, the engraving sensitivity tends to increase, which is preferable.

Specific examples of the photothermal conversion agent used in the present invention include cyanine-based dyes such as heptamethinecyanine dyes; oxonol-based dyes such as pentamethineoxonol dyes; indolium-based dyes, benzindolium-based dyes, benzothiazolium-based dyes, quinolinium-based dyes, and phthalide compounds that have been reacted with color developing agents. Not all the cyanine-based dyes have the light absorption characteristics described above. The light absorption characteristics vary to a very large extent depending on the type of a substituent and the position thereof in the molecule, the number of conjugated bonds, the type of the counterion, the environment in which the dye molecules exist, and the like.

Furthermore, laser dyes, supersaturation absorbing dyes, and near-infrared absorbing dyes that are commonly marketed can also be used. Examples of the laser dyes include “ADS740PP”, “ADS745HT”, “ADS760MP”, “ADS740WS”, “ADS765WS”, “ADS745HO”, “ADS790NH”, and “ADS800NH” (all trade names) manufactured by American Dye Source, Inc. (Canada); and “NK-3555”, “NK-3509”, and “NK-3519” (all trade names) manufactured by Hayashibara Biochemical Laboratories, Inc. Also, examples of the near-infrared absorbing dyes include “ADS775MI”, “ADS775MP”, “ADS775HI”, “ADS775PI”, “ADS775PP”, “ADS780MT”, “ADS780BP”, “ADS793EI”, “ADS798MI”, “ADS798MP”, “ADS800AT”, “ADS805PI”, “ADS805PP”, “ADS805PA”, “ADS805 PF”, “ADS812MI”, “ADS815EI”, “ADS818HI”, “ADS818HT”, “ADS822MT”, “ADS830AT”, “ADS838MT”, “ADS840MT”, “ADS845BI”, “ADS905AM”, “ADS956BI”, “ADS1040T”, “ADS1040P”, “ADS1045P”, “ADS1050P”, “ADS1060A”, “ADS1065A”, “ADS1065P”, “ADS1100T”, “ADS1120F”, “ADS1120P”, “ADS780WS”, “ADS785WS”, “ADS790WS”, “ADS805WS”, “ADS820WS”, “ADS830WS”, “ADS850WS”, “ADS780HO”, “ADS810CO”, “ADS820HO”, “ADS821NH”, “ADS840NH”, “ADS880MC”, “ADS890MC”, and “ADS920MC” (all trade names) manufactured by American Dye Source, Inc. (Canada); “YKR-2200”, “YKR-2081”, “YKR-2900”, “YKR-2100”, and “YKR-3071” (all trade names) manufactured by Yamamoto Chemicals, Inc.; “SDO-1000 B” (trade name) manufactured by Arimoto Chemical Co., Ltd.; and “NK-3508” and “NKX-114” (trade names) manufactured by Hayashibara Biochemical Laboratories, Inc. However, the dyes are not limited only to these.

Furthermore, as the phthalide compounds that have been reacted with color developing agents, those compounds described in JP-B-3271226 can be used. Also, phosphoric acid ester metal compounds, for example, complexes of the phosphoric acid esters and copper salts described in JP-A-6-345820 and WO 99/10354 can also be used. Furthermore, fine particles having light absorption characteristics in the near-infrared region and having a volume average particle size of preferably 0.3 μm or less, more preferably 0.1 μm or less, and particularly preferably 0.08 μm or less, can also be used. Examples thereof include metal oxides such as yttrium oxide, tin oxide and/or indium oxide, copper oxide, and iron oxide; and metals such as gold, silver, palladium and platinum. Furthermore, products produced by adding metal ions such as the ions of copper, tin, indium, yttrium, chromium, cobalt, titanium, nickel, vanadium and rare earth elements to particles of glass or the like having a volume average particle size of 5 μm or less, and more preferably 1 μm or less, can also be used. Furthermore, metal ions can also be incorporated into microcapsules. In that case, the volume average particle size of the capsule is preferably 10 μm or less, more preferably 5 μm or less, and even more preferably 1 μm or less. Products produced by adsorbing metal ions of copper, tin, indium, yttrium, and rare earth metals to ion exchanger particles can also be used. The ion exchanger particles may be resin particles or inorganic particles. Examples of the inorganic particles include amorphous zirconium phosphate, amorphous zirconium silicate, amorphous zirconium hexametaphosphate, layered zirconium phosphate, network-like zirconium phosphate, zirconium tungstenate, and zeolites. Examples of the resin particles include ion exchange resins and ion exchange celluloses, which are conventionally used.

Most preferred examples of the photothermal conversion agent particularly preferably used in the present invention include carbon black from the viewpoint of stability and efficiency of photothermal conversion. As carbon black, only if there is no such problem as dispersion instability in the composition constituting the relief-forming layer, any of carbon blacks usually used for various applications such as coloring, rubber and dry battery is preferably used, in addition to products falling within standards classified by ASTM.

The carbon black cited here also includes, for example, furnace black, thermal black, channel black, lampblack, acetylene black, etc. Black colorants such as carbon black can be used for the preparation of the thermally curable resin composition as a color chip or a color paste previously dispersed in nitrocellulose or a binder, while using a dispersing agent if necessary for making the dispersion easy. Such chips and pastes can easily be obtained as commercial products.

In the present invention, it is also possible to use carbon blacks having a relatively low specific surface area and relatively low DBP absorption, and microfabricated carbon blacks having a large specific surface area.

Examples of the favorable commercial products of carbon black include Printex U (registered trade mark), Printex A (registered trade mark) and Spezialschwarz 4 (registered trade mark) (all are manufactured by Degussa), SEAST 600 ISAF-LS (manufactured by Tokai Carbon Co., Ltd.), Asahi #70 (N-300) and Asahi #80 (N-220) (manufactured by ASAHI CARBON CO., LTD.), etc.

According to the present invention, a carbon black having an amount of oil absorption of less than 150 ml/100 g is preferable, from the viewpoint of the dispersibility in the thermally curable resin composition.

For the selection of such a carbon black, for example, reference can be made to ‘Carbon Black Binran’ (Carbon Black Handbook) edited by the Carbon Black Association.

When a carbon black having an amount of oil absorption of less than 150 ml/100 g is used, satisfactory dispersibility in the relief-forming layer can be obtained, which is preferable. On the other hand, when a carbon black having an amount of oil absorption of 150 ml/100 g or more is used, the dispersibility in the coating liquid for relief-forming layer tends to deteriorate, and since aggregation of carbon black is likely to occur, the sensitivity becomes non-uniform, which is not preferable. Furthermore, for the purpose of preventing aggregation, it is necessary to intensify the dispersion of carbon black at the time of preparing the coating liquid.

As a method of dispersing Component C, known dispersion techniques that are used in the ink production or toner production can be employed. Examples of dispersion machines include an ultrasonic dispersion machine, a paint shaker, a sand mill, an attritor, a pearl mill, a super mill, a ball mill, an impeller, a disperser, a KD mill, a colloid mill, a dynatron, a three-roll mill, and a pressure kneader. The details are described in Saishin Ganryo Ohyo Gijutsu (Current Pigment Application Technologies), published by CMC Publishing Co., Ltd. (1986).

The content of Component C depends on the numerical value of the molecular extinction coefficient characteristic to the molecule, and is preferably in the range of 0.1 to 15 wt % relative to the total weight of the composition for laser engraving, more preferably 0.5 to 10 wt %, and particularly preferably 1 to 8 wt %.

The volume-average particle size of Component C is preferably in the range of 0.001 to 10 μm, more preferably 0.01 to 10 μm, and particularly preferably 0.01 to 1 μm.

The volume-average particle size of Component C may be measured using a laser-scattering type particle size distribution analyzer.

<(Component D) Compound Having Hydrolyzable Silyl Group and/or Silanol Group>

In the present invention, the thermally curable layer may preferably further comprise (Component D) a compound having a hydrolyzable silyl group and/or a silanol group.

The ‘hydrolyzable silyl group’ of (Component D) a compound having a hydrolyzable silyl group and/or a silanol group (hereinafter, called ‘Component D’ as appropriate) preferably used in the composition for laser engraving of the present invention is a silyl group that has a hydrolyzable group; examples of hydrolyzable groups include an alkoxy group, a mercapto group, a halogen atom, an amide group, an acetoxy group, an amino group, and an isopropenoxy group. A silyl group is hydrolyzed to become a silanol group, and a silanol group undergoes dehydration-condensation to form a siloxane bond. Such a hydrolyzable silyl group or a silanol group is preferably one represented by Formula (1) below.

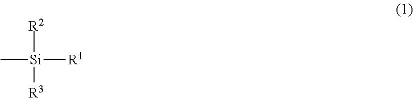

In Formula (1) above, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group. The remainder of R¹ to R³ independently denotes a hydrogen atom, a halogen atom, or a monovalent organic substituent (examples including an alkyl group, an aryl group, an alkenyl group, an alkynyl group, and an aralkyl group).

In Formula (1) above, the hydrolyzable group bonded to the silicon atom is particularly preferably an alkoxy group or a halogen atom, and more preferably an alkoxy group.

From the viewpoint of rinsing properties and printing durability, the alkoxy group is preferably an alkoxy group having 1 to 30 carbon atoms, more preferably an alkoxy group having 1 to 15 carbon atoms, yet more preferably an alkoxy group having 1 to 5 carbon atoms, particularly preferably an alkoxy group having 1 to 3 carbon atoms, and most preferably a methoxy group or an ethoxy group.

Furthermore, examples of the halogen atom include an F atom, a Cl atom, a Br atom, and an I atom, and from the viewpoint of ease of synthesis and stability it is preferably a Cl atom or a Br atom, and more preferably a Cl atom.

Component D in the present invention is preferably a compound having one or more groups represented by Formula (1) above, and more preferably a compound having two or more. A compound having two or more hydrolyzable silyl groups is particularly preferably used. That is, a compound having in the molecule two or more silicon atoms having a hydrolyzable group bonded thereto is preferably used. The number of silicon atoms having a hydrolyzable group bond thereto contained in Component D is preferably at least 2 but no greater than 6, and most preferably 2 or 3.

A range of 1 to 4 of the hydrolyzable groups may bond to one silicon atom, and the total number of hydrolyzable groups in Formula (1) is preferably in a range of 2 or 3. It is particularly preferable that three hydrolyzable groups are bonded to a silicon atom. When two or more hydrolyzable groups are bonded to a silicon atom, they may be identical to or different from each other.

Specific preferred examples of the alkoxy group include a methoxy group, an ethoxy group, a propoxy group, an isopropoxy group, a butoxy group, a tert-butoxy group, a phenoxy group, and a benzyloxy group. A plurality of each of these alkoxy groups may be used in combination, or a plurality of different alkoxy groups may be used in combination.

Examples of the alkoxysilyl group having an alkoxy group bonded thereto include a trialkoxysilyl group such as a trimethoxysilyl group, a triethoxysilyl group, a triisopropoxysilyl group, or a triphenoxysilyl group; a dialkoxymonoalkylsilyl group such as a dimethoxymethylsilyl group or a diethoxymethylsilyl group; and a monoalkoxydialkylsilyl group such as a methoxydimethylsilyl group or an ethoxydimethylsilyl group.

Component D preferably has at least a sulfur atom, an ester bond, a urethane bond, an ether bond, a urea bond, or an imino group.

Among them, from the viewpoint of crosslinkability, Component D preferably comprises a sulfur atom, and from the viewpoint of removability (rinsing properties) of engraving residue it is preferable for it to comprise an ester bond, a urethane bond, or an ether bond (in particular, an ether bond contained in an oxyalkylene group), which are easily decomposed by aqueous alkali. Component D containing a sulfur atom functions as a vulcanizing agent or a vulcanization accelerator at the time of vulcanization treatment, and accelerates the reaction (crosslinking) of the polymer containing a conjugated diene monomer unit. As a result, Component D exhibits rubber elasticity that is needed as a flexographic printing plate. Also, Component D enhances the strength of the crosslinked relief-forming layer and the relief layer.

Furthermore, Component D according to the present invention is preferably a compound which does not have an ethylenically unsaturated bond.

As Component D in the present invention, there can be preferably cited a compound in which a plurality of groups represented by Formula (1) above are bonded via a divalent linking group, and from the viewpoint of the effect, such a divalent linking group is preferably a linking group having a sulfide group (—S—), an imino group (—N(R)—), a urea group, or a urethane bond (—OCON(R)— or —N(R)COO—). R denotes a hydrogen atom or a substituent. Examples of the substituent denoted by R include an alkyl group, an aryl group, an alkenyl group, an alkynyl group, and an aralkyl group.

A method for synthesizing Component D is not particularly limited, and synthesis can be carried out by a known method. As one example, a representative synthetic method for a Component D containing a linking group having the above-mentioned specific structure is shown below.

<Synthetic Method for Compound Having Sulfide Group as Linking Group and Having Hydrolyzable Silyl Group and/or Silanol Group>

A synthetic method for a Component D having a sulfide group as a linking group (hereinafter, called as appropriate a ‘sulfide linking group-containing Component D’) is not particularly limited, but specific examples thereof include reaction of a Component D having a halogenated hydrocarbon group with an alkali metal sulfide, reaction of a Component D having a mercapto group with a halogenated hydrocarbon, reaction of a Component D having a mercapto group with a Component D having a halogenated hydrocarbon group, reaction of a Component D having a halogenated hydrocarbon group with a mercaptan, reaction of a Component D having an ethylenically unsaturated double bond with a mercaptan, reaction of a Component D having an ethylenically unsaturated double bond with a Component D having a mercapto group, reaction of a compound having an ethylenically unsaturated double bond with a Component D having a mercapto group, reaction of a ketone with a Component D having a mercapto group, reaction of a diazonium salt with a Component D having a mercapto group, reaction of a Component D having a mercapto group with an oxirane, reaction of a Component D having a mercapto group with a Component D having an oxirane group, reaction of a mercaptan with a Component D having an oxirane group, and reaction of a Component D having a mercapto group with an aziridine.

<Synthetic Method for Compound Having Imino Group as Linking Group and Having Hydrolyzable Silyl Group and/or Silanol Group>

A synthetic method for a Component D having an imino group as a linking group (hereinafter, called as appropriate an ‘imino linking group-containing Component D’) is not particularly limited, but specific examples include reaction of a Component D having an amino group with a halogenated hydrocarbon, reaction of a Component D having an amino group with a Component D having a halogenated hydrocarbon group, reaction of a Component D having a halogenated hydrocarbon group with an amine, reaction of a Component D having an amino group with an oxirane, reaction of a Component D having an amino group with a Component D having an oxirane group, reaction of an amine with a Component D having an oxirane group, reaction of a Component D having an amino group with an aziridine, reaction of a Component D having an ethylenically unsaturated double bond with an amine, reaction of a Component D having an ethylenically unsaturated double bond with a Component D having an amino group, reaction of a compound having an ethylenically unsaturated double bond with a Component D having an amino group, reaction of a compound having an acetylenically unsaturated triple bond with a Component D having an amino group, reaction of a Component D having an imine-based unsaturated double bond with an organic alkali metal compound, reaction of a Component D having an imine-based unsaturated double bond with an organic alkaline earth metal compound, and reaction of a carbonyl compound with a Component D having an amino group.

<Synthetic Method for Compound Having Urea Bond as Linking Group and Having Hydrolyzable Silyl Group and/or Silanol Group>

A synthetic method for Component D having an urea bond (hereinafter, called as appropriate a ‘urea linking group-containing Component D’) as a linking group is not particularly limited, but specific examples include synthetic methods such as reaction of a Component D having an amino group with an isocyanate ester, reaction of a Component D having an amino group with a Component D having an isocyanate ester, and reaction of an amine with a Component D having an isocyanate ester.

Component D is preferably a compound represented by Formula (A-1) or Formula (A-2) below.

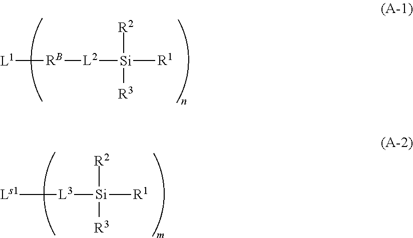

(In Formula (A-1) and Formula (A-2), R^{B} denotes an ester bond, an amide bond, a urethane bond, a urea bond, or an imino group, L¹ denotes an n-valent linking group, L² denotes a divalent linking group, L^{s1} denotes an m-valent linking group, L³ denotes a divalent linking group, n and m independently denote an integer of 1 or greater, and R¹ to R³ independently denote a hydrogen atom, a halogen atom, or a monovalent organic substituent. In addition, at least one of R¹ to R³ denotes a hydrolyzable group selected from the group consisting of an alkoxy group, a mercapto group, a halogen atom, an amide group, an acetoxy group, an amino group, and an isopropenoxy group, or a hydroxy group.)

R¹ to R³ in Formula (A-1) and Formula (A-2) above have the same meanings as those of R¹ to R³ in Formula (1) above, and preferred ranges are also the same.

From the viewpoint of rinsing properties and film strength, R^{B} above is preferably an ester bond or a urethane bond, and is more preferably an ester bond.

The divalent or n-valent linking group denoted by L¹ to L³ above is preferably a group formed from at least one type of atom selected from the group consisting of a carbon atom, a hydrogen atom, an oxygen atom, a nitrogen atom, and a sulfur atom, and is more preferably a group formed from at least one type of atom selected from the group consisting of a carbon atom, a hydrogen atom, an oxygen atom, and a sulfur atom. The number of carbon atoms of L¹ to L³ above is preferably 2 to 60, and more preferably 2 to 30.

The m-valent linking group denoted by L^{s1} above is preferably a group formed from a sulfur atom and at least one type of atom selected from the group consisting of a carbon atom, a hydrogen atom, an oxygen atom, a nitrogen atom, and a sulfur atom, and is more preferably an alkylene group or a group formed by combining two or more from an alkylene group, a sulfide group, and an imino group. The number of carbon atoms of L″ above is preferably 2 to 60, and more preferably 6 to 30.

n and m above are independently integers of 1 to 10, more preferably integers of 2 to 10, yet more preferably integers of 2 to 6, and particularly preferably 2.

From the viewpoint of removability (rinsing properties) of engraving residue, the n-valent linking group denoted by L¹ and/or the divalent linking group denoted by L², or the divalent linking group denoted by L³ preferably has an ether bond, and more preferably has an ether bond contained in an oxyalkylene group.

Among compounds represented by Formula (A-1) or Formula (A-2), from the viewpoint of crosslinkability, etc., the n-valent linking group denoted by L¹ and/or the divalent linking group denoted by L² in Formula (A-1) are preferably groups having a sulfur atom.

Specific examples of Component D that can be applied to the present invention are shown below. Examples thereof include vinyltrichlorosilane, vinyltrimethoxysilane, vinyltriethoxysilane, β-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, p-styryltrimethoxysilane, γ-methacryloxypropyltrimethoxysilane, γ-methacryloxypropylmethyldiethoxysilane, γ-methacryloxypropyltriethoxysilane, γ-acryloxypropyltrimethoxysilane, N-(β-aminoethyl)-γ-aminopropylmethyldimethoxysilane,
N-(β-aminoethyl)-γ-aminopropyltrimethoxysilane,
N-(β-aminoethyl)-γ-aminopropyltriethoxysilane, γ-aminopropyltrimethoxysilane, γ-aminopropyltriethoxysilane, N-phenyl-γ-aminopropyltrimethoxysilane, γ-mercaptopropyltrimethoxysilane, γ-mercaptopropyltriethoxysilane, mercaptomethyltrimethoxysilane, dimethoxy-3-mercaptopropylmethylsilane, 2-(2-aminoethylthioethyl)diethoxymethylsilane, 3-(2-acetoxyethylthiopropyl)dimethoxymethylsilane, 2-(2-aminoethylthioethyl)triethoxysilane, dimethoxymethyl-3-(3-phenoxypropylthiopropyl)silane, bis(triethoxysilylpropyl)disulfide, bis(triethoxysilylpropyl)tetrasulfide, 1,4-bis(triethoxysilyl)benzene, bis(triethoxysilyl)ethane, 1,6-bis(trimethoxysilyl)hexane, 1,8-bis(triethoxysilyl)octane, 1,2-bis(trimethoxysilyl)decane, bis(triethoxysilylpropyl)amine, bis(trimethoxysilylpropyl)urea, γ-chloropropyltrimethoxysilane, γ-ureidopropyltriethoxysilane, trimethylsilanol, diphenylsilanediol, and triphenylsilanol. Other than the above, the compounds shown below can be cited as preferred examples, but the present invention should not be construed as being limited thereto.

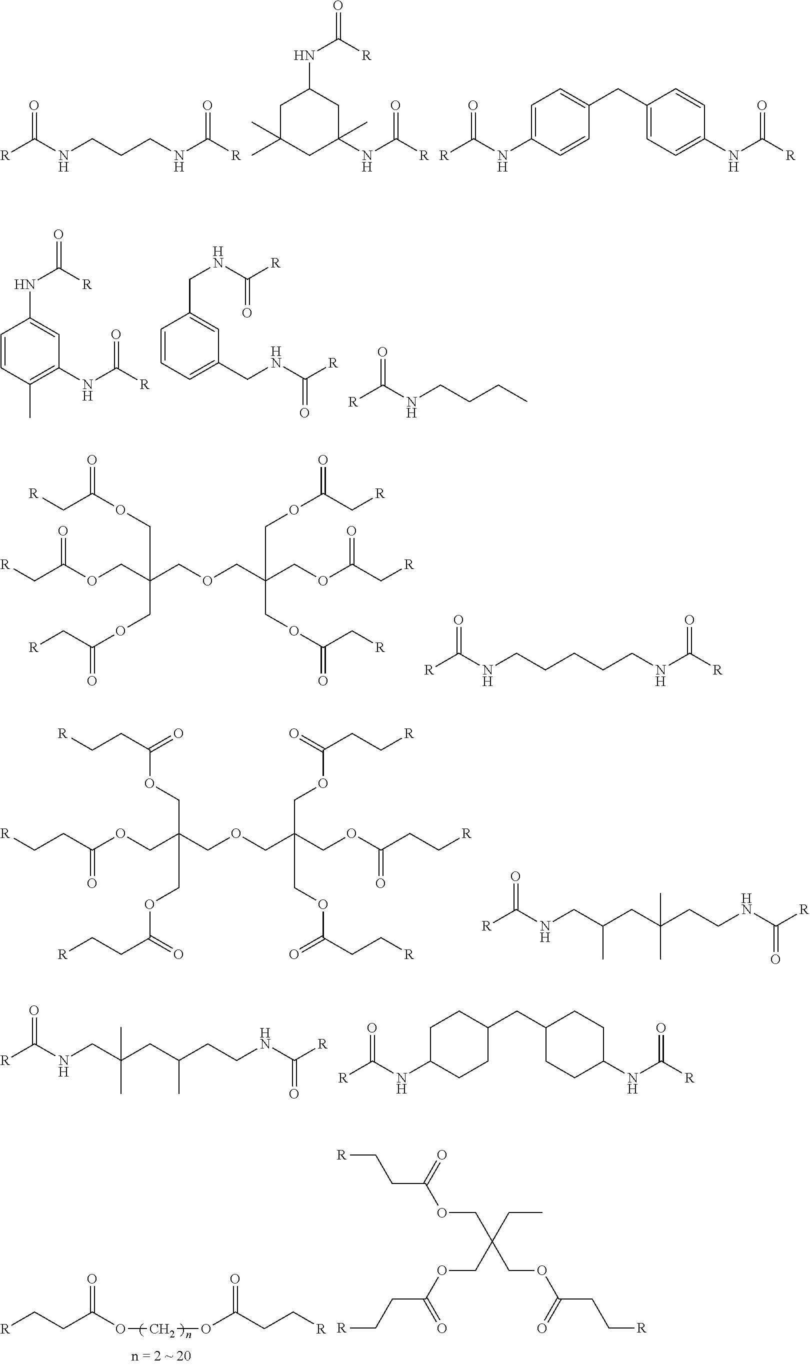

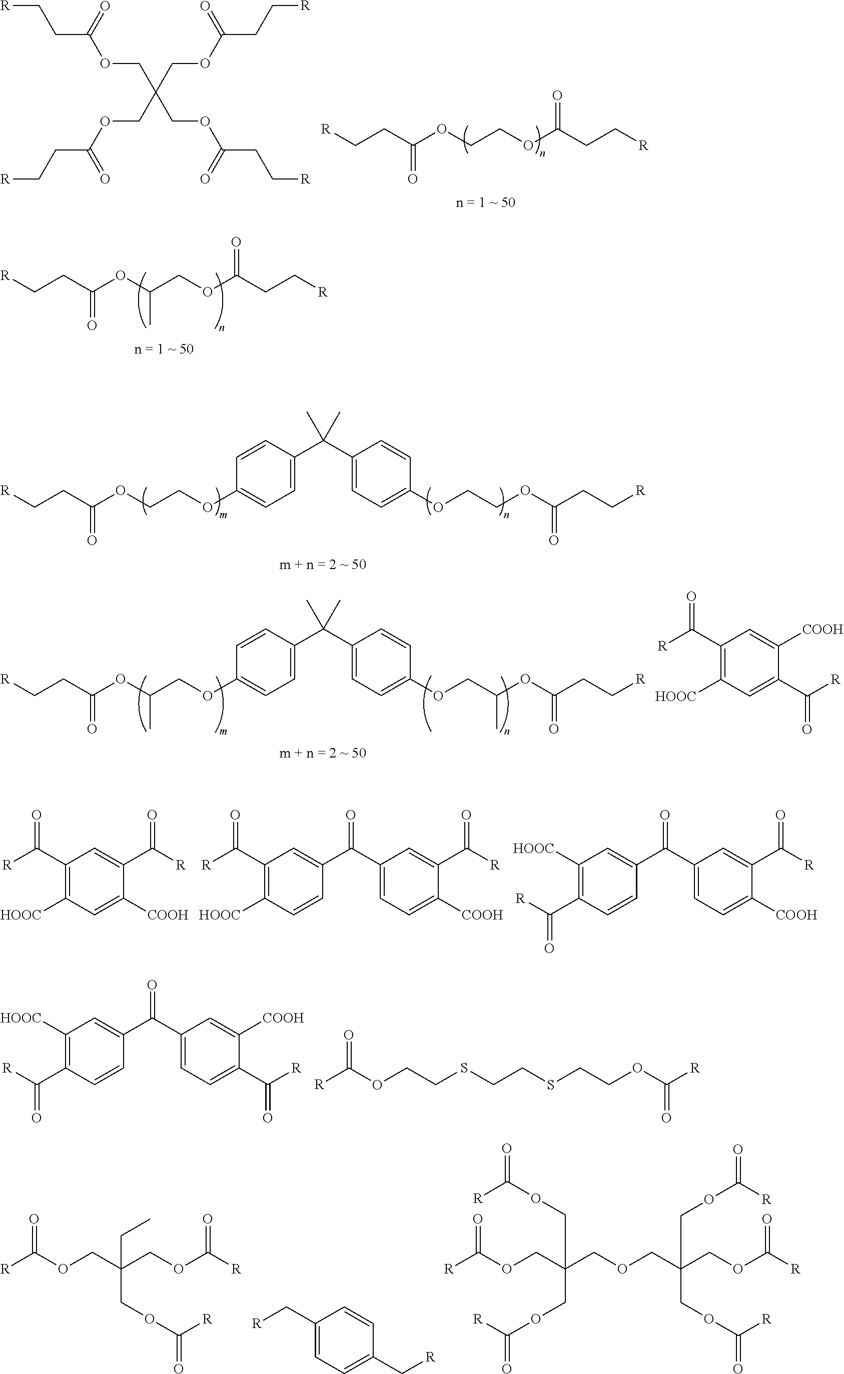

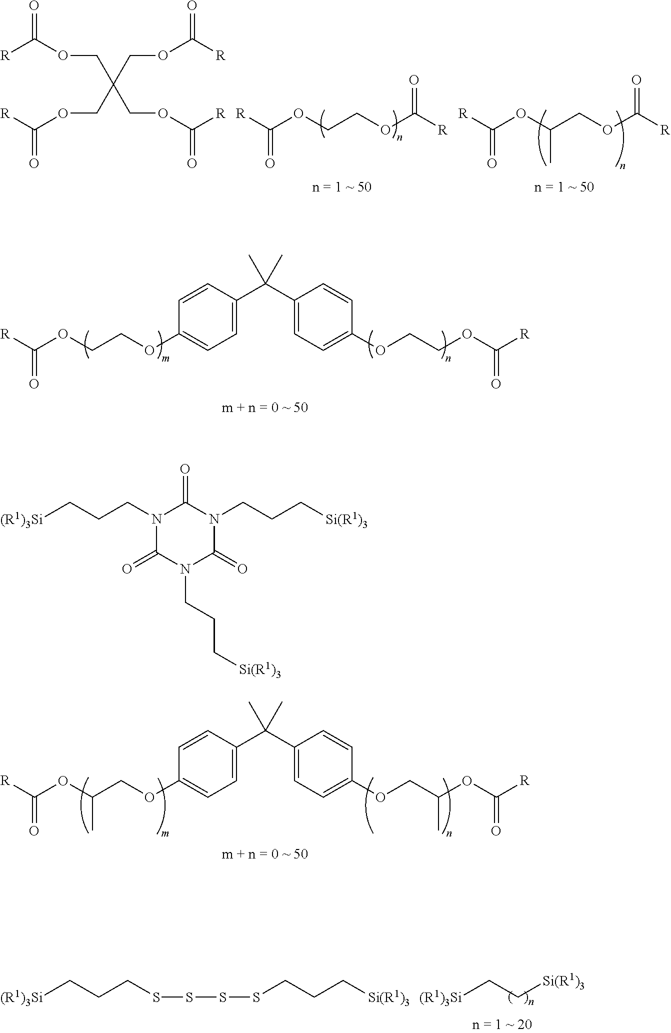

In each of the formulae above, R denotes a partial structure selected from the structures below. When a plurality of Rs and R¹s are present in the molecule, they may be identical to or different from each other, and are preferably identical to each other in terms of synthetic suitability.

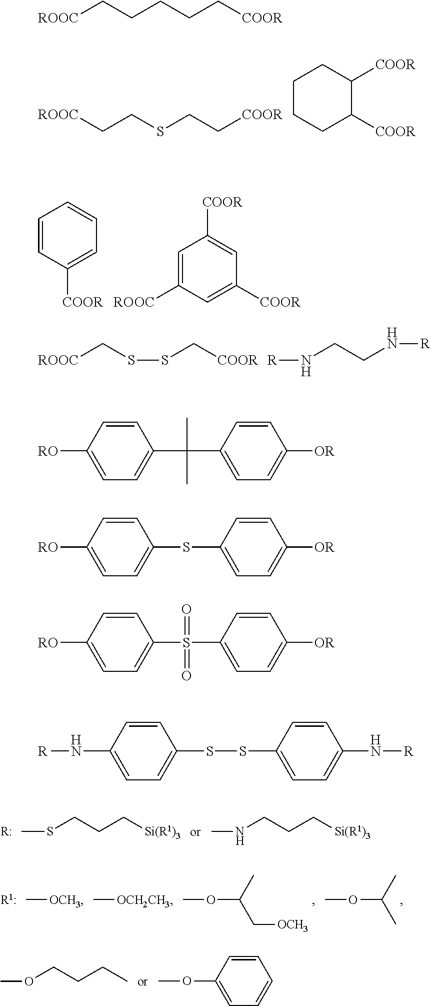

In each of the formulae above, R denotes a partial structure shown below. R¹ is the same as defined above. When a plurality of Rs and R¹s are present in the molecule, they may be identical to or different from each other, and in terms of synthetic suitability are preferably identical to each other.

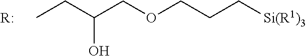

Component D may be obtained by synthesis as appropriate, but use of a commercially available product is preferable in terms of cost. Since Component D corresponds to for example commercially available silane products or silane coupling agents from Shin-Etsu Chemical Co., Ltd., Dow Corning Toray, Momentive Performance Materials Inc., Chisso Corporation, etc., the thermally curable resin composition used in the present invention may employ such a commercially available product by appropriate selection according to the intended application.

As Component D in the present invention, a partial hydrolysis-condensation product obtained using one type of compound having a hydrolyzable silyl group and/or a silanol group or a partial cohydrolysis-condensation product obtained using two or more types may be used. Hereinafter, these compounds may be called ‘partial (co)hydrolysis-condensation products’.

Among silane compounds as partial (co)hydrolysis-condensation product precursors, from the viewpoint of versatility, cost, and film compatibility, a silane compound having a substituent selected from a methyl group and a phenyl group as a substituent on the silicon is preferable, and specific preferred examples of the precursor include methyltrimethoxysilane, methyltriethoxysilane, phenyltrimethoxysilane, phenyltriethoxysilane, dimethyldimethoxysilane, dimethyldiethoxysilane, diphenyldimethoxysilane, and diphenyldiethoxysilane.

In this case, as a partial (co)hydrolysis-condensation product, it is preferable to use a dimer (2 moles of silane compound is reacted with 1 mole of water to eliminate 2 moles of alcohol, thus giving a disiloxane unit) to 100-mer of the above-mentioned silane compound, preferably a dimer to 50-mer, and yet more preferably a dimer to 30-mer, and it is also possible to use a partial cohydrolysis-condensation product formed using two or more types of silane compounds as starting materials.

As such a partial (co)hydrolysis-condensation product, ones commercially available as silicone alkoxy oligomers may be used (e.g. those from Shin-Etsu Chemical Co., Ltd.) or ones that are produced in accordance with a standard method by reacting a hydrolyzable silane compound with less than an equivalent of hydrolytic water and then removing by-products such as alcohol and hydrochloric acid may be used. When the production employs, for example, an acyloxysilane or an alkoxysilane described above as a hydrolyzable silane compound starting material, which is a precursor, partial hydrolysis-condensation may be carried out using as a reaction catalyst an acid such as hydrochloric acid or sulfuric acid, an alkali metal or alkaline earth metal hydroxide such as sodium hydroxide or potassium hydroxide, or an alkaline organic material such as triethylamine, and when the production is carried out directly from a chlorosilane, water and alcohol may be reacted using hydrochloric acid by-product as a catalyst.

With regard to Component D in the composition for laser engraving of the present invention, only one type may be used or two or more types may be used in combination.

The content of Component D contained in the composition for laser engraving of the present invention is preferably in the range of 0.1 to 80 wt % on a solids content basis, more preferably in the range of 1 to 40 wt %, and most preferably in the range of 5 to 30 wt %.

### (Component E) Binder Polymer

The composition for laser engraving of the present invention preferably comprises (Component E) a binder polymer.

The binder polymer is preferably a binding resin having a weight average molecular weight of 500 to 1,000,000, and although not particularly limited, generally polymer compounds may be appropriately selected and used individually, or in combination of two or more kinds. It is preferable to select the binder polymer by particularly taking into consideration of various performances such as laser engraving properties, ink receptibility, and engraving residue dispersibiltiy.

As the binder polymer, a polystyrene resin, a polyester resin, a polyamide resin, a polysulfone resin, a polyether sulfone resin, a polyimide resin, a hydrophilic polymer containing a hydroxyethylene unit, an acrylic resin, an acetal resin, an epoxy resin, a polycarbonate resin, rubber, a thermoplastic elastomer or the like can be selected and used.

For example, from the viewpoint of the laser engraving sensitivity, a polymer containing a partial structure which is thermally degraded by exposure or heating is preferred. Preferred examples of such a polymer include the polymers described in paragraph [0038] of JP-A-2008-163081. Furthermore, for example, when it is intended to form a soft and flexible film, a soft resin or a thermoplastic elastomer is selected. Such polymers are described in detail in paragraphs [0039] to [0040] of JP-A-2008-163081. Furthermore, from the viewpoints of the ease of preparation of a composition for laser engraving, and an increase in the resistance against oily ink in the obtained flexographic printing plate thus obtained, it is preferable to use a hydrophilic or alcoholphilic polymer. Examples of a hydrophilic polymer that can be used include those polymers described in detail in paragraph [0041] of JP-A-2008-163081.

According to the present invention, the binder polymer is such that from the viewpoints of engraving formation and rinsability, a non-elastomeric binder is preferred to an elastomeric binder as the binder polymer. Here, the non-elastomeric binder means a binder polymer having a glass transition temperature (Tg) of 20° C. or higher. Meanwhile, when a binder polymer has plural glass transition temperatures, all the glass transition temperatures are 20° C. or higher. That is, an elastomer is academically defined as a polymer having a glass transition temperature that is equal to or higher than normal temperature (see Kagaku Daijiten (Science Dictionary), 2^{nd} edition, edited by the Foundation for Advancement of International Science, published by Maruzen Co., Ltd., refer to p. 154). Therefore, a non-elastomer refers to a polymer having a glass transition temperature higher than normal temperature. The upper limit of the glass transition temperature of the binder polymer is not particularly limited, but the glass transition temperature is preferably 200° C. or lower from the viewpoint of handling properties, and more preferably from 25° C. to 120° C.

Furthermore, in the case of using the binder polymer for the purpose of enhancing strength by curing the polymer by heating or exposure, a polymer having a hydroxyl group, an alkoxy group, a hydrolyzable silyl group and a silanol group, an ethylenically unsaturated bond, or the like in the molecule is preferably used.

The above reactive functional group may be present at any locations in polymer molecules, but is preferably present at the side chain of the chain polymer. Preferred examples of such a polymer include a vinyl copolymer (copolymer of a vinyl monomer such as polyvinyl alcohol and polyvinyl acetal, and a derivative thereof) and an acrylic resin (copolymer of an acryl-based monomer such as hydroxyethyl(meth)acrylate, and a derivative thereof).

A method of introducing the reactive functional group into the binder polymer is not particularly limited, and a method of addition-(co)polymerizing or addition-polycondensating a monomer having the reactive functional group and a method in which, after synthesizing a polymer having a group which can be introduced into the reactive functional group, the group of the polymer is introduced into the reactive functional group by polymer reaction are included thereto.

As a binder polymer, a binder polymer having a hydroxyl group (E-1) is preferably used. (E-1) is explained below.

### (E-1) Binder Polymer Having Hydroxyl Group

As the binder polymer for the composition for laser engraving of the present invention, (E-1) a binder polymer having a hydroxyl group (hereinafter, also referred to as “specific polymer”) is preferred. This specific polymer is water-insoluble, and is preferably soluble in an alcohol having 1 to 4 carbon atoms.

Preferred examples of E-1 for a flexographic printing plate precursor for laser engraving which is well balanced between the suitability to aqueous ink and the suitability to UV ink, and has high engraving sensitivity and satisfactory film formabiltiy, include polyvinyl acetal and derivatives thereof, acrylic resins having hydroxyl groups in side chains, and epoxy resins having hydroxyl groups in side chains.

E-1 is preferably such that the glass transition temperature (Tg) is 20° C. or higher. When E-1 is combined with Component C, that is, a photothermal conversion agent, the engraving sensitivity is enhanced by adjusting to the glass transition temperature (Tg) of the binder polymer to 20° C. or higher. A binder polymer having such a glass transition temperature will be also referred to as a “non-elastomer”. The upper limit of the glass transition temperature of the binder polymer is not particularly limited, but the glass transition temperature is preferably 200° C. or lower from the viewpoint of handling properties, and more preferably from 25° C. to 120° C.

In the case of using a polymer having a glass transition temperature equal to or higher than room temperature (20° C.), the specific polymer adopts a glassy state at normal temperature. However, for this reason, the thermal molecular motion is in a fairly suppressed state, as compared with the case where the specific polymer adopts a rubbery state. It is speculated that at the time of laser engraving, at the time of laser irradiation, the heat applied by infrared laser light as well as the heat generated by the function of (Component C) a photothermal conversion agent is transferred to the specific polymer present in the surrounding, and the specific polymer is thermally degraded and dissipated, so that as a result, engraving is achieved, and depressions are formed.

It is thought that when the specific polymer is used, if a photothermal conversion agent exists in a state in which the thermal molecular motion of the specific polymer is suppressed, heat transfer to the specific polymer and thermal degradation occur effectively, and it is speculated that the engraving sensitivity is further increased by such an effect.

Specific examples of non-elastomer polymers that are preferably used in the present invention will be listed below.

### (1) Polyvinyl Acetal and its Derivative

Polyvinyl acetal is a compound obtained by converting polyvinyl alcohol (obtained by saponifying polyvinyl acetate) into a cyclic acetal. The polyvinyl acetal derivative is preferably a derivative obtained by modifying the polyvinyl acetal or adding another copolymer constituent.

The acetal content in the polyvinyl acetal derivative (mole % of vinyl alcohol units converted into acetal relative to the total number of moles of vinyl acetate monomer starting material as 100 mole %) is preferably 30 to 90 mole %, more preferably 50 to 85 mole %, and particularly preferably 55 to 78 mole %.

The vinyl alcohol unit in the polyvinyl acetal derivatives is preferably 10 to 70 mole % relative to the total number of moles of the vinyl acetate monomer starting material, more preferably 15 to 50 mole %, and particularly preferably 22 to 45 mole %.

Furthermore, the polyvinyl acetal may have a vinyl acetate unit as another component, and the content thereof is preferably 0.01 to 20 mole %, and more preferably 0.1 to 10 mole %. The polyvinyl acetal derivative may further have another copolymerized constitutional unit.

Examples of the polyvinyl acetal include polyvinyl butyral, polyvinyl propylal, polyvinyl ethylal, and polyvinyl methylal. Among them, polyvinyl butyral derivative (PVB) is particularly preferably used.

Polyvinyl butyral is conventionally obtained by converting polyvinyl alcohol into polyvinyl bytyral. Polyvinyl butyral derivatives may be also used.

Examples of the polyvinyl butyral derivatives include an acid-modified PVB in which at least some of the hydroxy groups are modified with an acid group such as a carboxy group, a modified PVB in which some of the hydroxy groups are modified with a (meth)acryloyl group, a modified PVB in which at least some of the hydroxy groups are modified with an amino group, a modified PVB in which at least some of the hydroxy groups have introduced thereinto ethylene glycol, propylene glycol, or a multimer thereof.

From the viewpoint of a balance being achieved between engraving sensitivity and film formation properties, the weight-average molecular weight of the polyvinyl acetal is preferably 5,000 to 800,000, more preferably 8,000 to 500,000 and, from the viewpoint of improvement of rinsing properties for engraving residue, particularly preferably 50,000 to 300,000.

Hereinafter, polyvinyl butyral (PVB) and derivatives thereof are cited for explanation as particularly preferred examples of polyvinyl acetal, but are not limited to these.

Polyvinyl butyral has a structure as shown below, and is constituted while including these structural units.

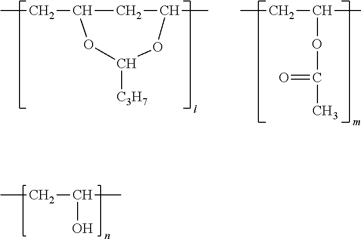

In the above Formula, l, m, and n denote the content (mole %) in polyvinyl butyral of the respective repeating units and the relationship I+m+n=100 is satisfied. The butyral content in the polyvinyl butyral and the derivative thereof (value of l in the formula above) is preferably 30 to 90 mole %, more preferably 40 to 85 mole %, and particularly preferably 45 to 78 mole %.

From the viewpoint of a balance being achieved between engraving sensitivity and film formation properties, the weight-average molecular weight of the polyvinyl butyral and the derivative thereof is preferably 5,000 to 800,000, more preferably 8,000 to 500,000 and, from the viewpoint of improvement of rinsing properties for engraving residue, particularly preferably 50,000 to 300,000.

The PVB derivative is also available as a commercial product, and preferred examples thereof include, from the viewpoint of alcohol (particularly, ethanol) dissolving capability, “S-REC B” series and “S-REC K (KS)” series manufactured by SEKISUI CHEMICAL CO., LTD. and “DENKA BUTYRAL” manufactured by DENKI KAGAKU KOGYO KABUSHIKI KAISHA. From the viewpoint of alcohol (particularly, ethanol) dissolving capability, “S-REC B” series manufactured by SEKISUI CHEMICAL CO., LTD. and “DENKA BUTYRAL” manufactured by DENKI KAGAKU KOGYO KABUSHIKI KAISHA are more preferable. Among these, particularly preferable commercial products are shown below along with the values l, m, and n in the above formulae and the molar weight. Examples of “S-REC B” series manufactured by SEKISUI CHEMICAL CO., LTD. include “BL-1” (l=61, m=3, n=36, weight-average molecular weight: 19,000), “BL-1H” (l=67, m=3, n=30, weight-average molecular weight: 20,000), “BL-2” (l=61, m=3, n=36, weight-average molecular weight: about 27,000), “BL-5” (l=75, m=4, n=21, weight-average molecular weight: 32,000), “BL-S” (l=74, m=4, n=22, weight-average molecular weight: 23,000), “BM-S” (l=73, m=5, n=22, weight-average molecular weight: 53,000), and “BH-S” (l=73, m=5, n=22, weight-average molecular weight: 66,000), and examples of “DENKA BUTYRAL” manufactured by DENKI KAGAKU KOGYO include “#3000-1” (l=71, m=1, n=28, weight-average molecular weight: 74,000), “#3000-2” (l=71, m=1, n=28, weight-average molecular weight: 90,000), “#3000-4” (l=71, m=1, n=28, weight-average molecular weight: 117,000), “#4000-2” (l=71, m=1, n=28, weight-average molecular weight: 152,000), “#6000-C” (l=64, m=1, n=35, weight-average molecular weight: 308,000), “#6000-EP” (l=56, m=15, n=29, weight-average molecular weight: 381,000), “#6000-CS” (l=74, m=1, n=25, weight-average molecular weight: 322,000), and “#6000-AS” (l=73, m=1, n=26, weight-average molecular weight: 242,000).

When the relief-forming layer is formed using the PVB derivative as a specific polymer, a method of casting and drying a solution in which a solvent is dissolved is preferable from the viewpoint of smoothness of the film surface.

### (2) Acrylic Resin

An acrylic resin that can be used as a specific polymer is preferably an acrylic resin which can be synthesized from a known (meth)acrylic monomer and has a hydroxy group in the molecule.

Preferred examples of the (meth)acrylic monomer used for synthesizing the acrylic resin having a hydroxy group include for example a (meth)acrylic acid ester, a crotonic acid ester, or a (meth)acrylamide that has a hydroxy group in the molecule. Specific examples of such a monomer include 2-hydroxyethyl(meth)acrylate, 2-hydroxypropyl(meth)acrylate, and 4-hydroxybutyl(meth)acrylate.

In the present invention ‘(meth)acryl’ means ‘acryl’ and/or ‘methacryl’ and ‘(meth)acrylate’ means ‘acrylate’ and/or ‘methacrylate.’

The acrylic resin may be constituted from a known (meth)acrylic comonomer other than the (meth)acrylic monomer having a hydroxy group explained above. Examples of the (meth)acrylic monomer include methyl(meth)acrylate, ethyl(meth)acrylate, n-propyl(meth)acrylate, isopropyl(meth)acrylate, n-butyl(meth)acrylate, isobutyl(meth)acrylate, t-butyl(meth)acrylate, n-hexyl(meth)acrylate, lauryl(meth)acrylate, 2-ethylhexyl(meth)acrylate, acetoxyethyl(meth)acrylate, phenyl(meth)acrylate, 2-methoxyethyl(meth)acrylate, 2-ethoxyethyl(meth)acrylate, 2-(2-methoxyethoxy)ethyl(meth)acrylate, cyclohexyl(meth)acrylate, t-butylcyclohexyl(meth)acrylate, benzyl(meth)acrylate, diethylene glycol monomethyl ether(meth)acrylate, diethylene glycol monoethyl ether(meth)acrylate, diethylene glycol monophenyl ether(meth)acrylate, triethylene glycol monomethyl ether(meth)acrylate, triethylene glycol monoethyl ether(meth)acrylate, dipropylene glycol monomethyl ether(meth)acrylate, polyethylene glycol monomethyl ether(meth)acrylate, polypropylene glycol monomethyl ether(meth)acrylate, the monomethyl ether(meth)acrylate of a copolymer of ethylene glycol and propylene glycol, N,N-dimethylaminoethyl(meth)acrylate, N,N-diethylaminoethyl(meth)acrylate, and N,N-dimethylaminopropyl(meth)acrylate.

Furthermore, a modified acrylic resin formed with a urethane group- or urea group-containing acrylic monomer may preferably be used.

Among these, from the viewpoint of aqueous ink resistance, an alkyl(meth)acrylate such as lauryl(meth)acrylate and an aliphatic cyclic structure-containing (meth)acrylate such as t-butylcyclohexyl(meth)acrylate are particularly preferable.

### (3) Novolac Resin

Furthermore, as the specific polymer, a novolac resin may be preferably used, this being a resin formed by condensation of a phenol and an aldehyde under acidic conditions.

Preferred examples of the novolac resin include a novolac resin obtained from phenol and formaldehyde, a novolac resin obtained from m-cresol and formaldehyde, a novolac resin obtained from p-cresol and formaldehyde, a novolac resin obtained from o-cresol and formaldehyde, a novolac resin obtained from octylphenol and formaldehyde, a novolac resin obtained from mixed m-/p-cresol and formaldehyde, and a novolac resin obtained from a mixture of phenol/cresol (any of m-, p-, o- or m-/p-, m-/o-, o-/p-mixtures) and formaldehyde.

With regard to these novolac resins, those having a weight-average molecular weight of 800 to 200,000 and a number-average molecular weight of 400 to 60,000 are preferable.

An epoxy resin having a hydroxy group in a side chain may be used as the specific polymer. A preferred example of the epoxy resin include an epoxy resin formed by polymerization, as a starting material monomer, of an adduct of bisphenol A and epichlorohydrin.

The epoxy resin preferably has a weight-average molecular weight of 800 to 200,000, and a number-average molecular weight of 400 to 60,000.

Among specific polymers, polyvinyl butyral derivatives are more preferable from the viewpoint of rinsing properties and printing durability when the polymer is formed into the relief-forming layer.

In specific polymers of any embodiment described above, the content of the hydroxyl group contained in the specific polymers in the present invention is preferably 0.1 to 15 mmol/g, and more preferably 0.5 to 7 mmol/g.

In the flexographic printing plate precursor for laser engraving, in addition to the specific polymer, known polymers such as those having no hydroxy group that are not included in the specific polymer can be used singly or in combination with the specific polymer. Hereinafter, such a polymer may also be called a general polymer.

The general polymer constitutes the main component included in the flexographic printing plate precursor for laser engraving, together with the specific polymer, and therefore, one kind or two or more kinds of general polymer compounds that are not included in the specific polymer can be appropriately selected and used. Particularly, when a flexographic printing plate precursor is used as a printing plate precursor, it is necessary to select a binder polymer while taking into consideration various performances such as laser engraving properties, ink acceptability, and engraving residue dispersibility.

The general polymer may be selected from polystyrene resin, polyester resin, polyamide resin, polyureapolyamideimide resin, polyurethane resin, polysulfone resin, polyether sulfone resin, polyimide resin, polycarbonate resin, hydroxyethylene unit-containing hydrophilic polymer, acrylic resin, acetal resin, polycarbonate resin, rubber, thermoplastic elastomer, etc.

For example, from the viewpoint of the laser engraving sensitivity, polymers having a partial structure capable of being thermally decomposed by exposure or heating are preferable. Examples of such polymers preferably include those described in JP-A-2008-163081, paragraph 0038. For example, when the film that is soft and flexible is needed, a soft elastomer or a thermoplastic elastomer is selected. Examples of such polymers include those described in detail in JP-A-2008-163081, paragraphs 0039-0040. Furthermore, from the viewpoint of easy preparation of the composition for laser engraving and improvement of the oil ink resistance of the flexographic printing plate thus obtained, it is preferable to use a hydrophilic polymer or an alcoholphilic polymer. Examples of the hydrophilic polymer include those described in detail in JP-A-2008-163081, paragraph 0041.

With regard to Component E in the composition for laser engraving used in the present invention, only one type may be used or two or more types may be used in combination.

The content of Component E contained in the composition for laser engraving of the present invention is, from the viewpoint of a balance being obtained between shape retention, water resistance, and engraving sensitivity of a coating, preferably 2 to 95 wt % of the total solids content of the composition for laser engraving of the present invention, more preferably 5 to 80 wt %, and particularly preferably 10 to 60 wt %.

### (Component F) Alcohol Exchange Reaction Catalyst

In the case of using Component D in the composition for laser engraving of the present invention, it is preferable to further comprise (Component F) an alcohol exchange reaction catalyst in order to accelerate the reaction with, for example, the specific polymer having a hydroxyl group.

As the alcohol exchange reaction catalyst, any reaction catalyst that is generally used can be applied without limitation.

Hereinafter, an acidic or a basic catalyst, and metal complex catalysts, which are representative alcohol exchange reaction catalysts, will be described in sequence.

### Acidic or Basic Catalyst

As the catalyst, an acidic or a basic compound is used as it is or in the form of a solution in which it is dissolved in a solvent such as water or an organic solvent (hereinafter, called an acidic catalyst or a basic catalyst). The concentration when dissolved in a solvent is not particularly limited, and it may be selected appropriately according to the properties of the acidic or basic compound used, desired catalyst content, etc.

The type of the acidic or basic catalyst is not limited, and examples of the acidic catalyst include halogenated hydrogen such as hydrochloric acid, nitric acid, sulfuric acid, sulfurous acid, hydrogen sulfide, perchloric acid, hydrogen peroxide, carbonic acid, carboxylic acids such as formic acid and acetic acid, substituted carboxylic acids in which R of a structural formula represented by RCOOH is substituted by another element or substituent, sulfonic acids such as benzenesulfonic acid, phosphoric acid, etc, and examples of the basic catalyst include an ammoniacal base such as aqueous ammonia, an amine such as ethyl amine and aniline etc. Among these, from the viewpoint of progressing fastly an alcohol exchange reaction in the layer, methanesulfonic acid, p-toluenesulfonic acid, pyridinium-p-toluene sulfonate, phosphoric acid, phosphonic acid, acetic acid, 1,8-diazabicyclo[5.4.0]undec-7-ene, and hexamethylenetetramine are preferable, and methanesulfonic acid, p-toluenesulfonic acid, phosphoric acid, 1,8-diazabicyclo[5.4.0]undec-7-ene, and hexamethylenetetramineare are particularly preferable.

### Metal Complex Catalyst

The metal complex catalyst that can be used as an alcohol exchange reaction catalyst in the present invention is preferably constituted from a metal element selected from Groups 2, 4, 5, and 13 of the periodic table and an oxo or hydroxy oxygen compound selected from p-diketones (acetylacetone is preferable), ketoesters, hydroxycarboxylic acids and esters thereof, amino alcohols, and enolic active hydrogen compounds.

Furthermore, among the constituent metal elements, a Group 2 element such as Mg, Ca, Sr, or Ba, a Group 4 element such as Ti or Zr, a Group 5 element such as V, Nb, or Ta, and a Group 13 element such as Al or Ga are preferable, and they form a complex having an excellent catalytic effect. Among them, a complex obtained from Zr, Al, or Ti is excellent and preferable, and more preferred examples of the metal complex catalyst include ethyl orthotitanate, etc.

These metal complex catalysts are excellent in terms of stability in an aqueous coating solution and an effect in promoting gelling in a sol-gel reaction when thermally drying, and among them, ethyl acetoacetate aluminum diisopropylate, aluminum tris(ethyl acetoacetate), a di(acetylacetonato)titanium complex salt, and zirconium tris(ethyl acetoacetate) are particularly preferable.

In the composition for laser engraving of the present invention, only one kind of an alcohol exchange reaction catalyst may be used, or two or more kinds may be used in combination. The content of the alcohol exchange reaction catalyst in the composition for laser engraving is preferably 0.01 wt % to 20 wt %, and more preferably 0.1 wt % to 10 wt %, based on the specific polymer having a hydroxyl group.

### (Other Components)

In the composition for laser engraving of the present invention, other components that are adequate for the application, production method and the like can be appropriately added. In the following, preferred examples of additives will be described.

### <Polymerization Inhibitor>

In the present invention, in addition to the above-mentioned constitutional components, a small amount of thermal polymerization inhibitor may be added in order to inhibit undesired thermal polymerization of the compound having a polymerizable ethylenically unsaturated bond during the production process or the storage of the composition for laser engraving. Examples of the suitable thermal polymerization inhibitors include hydroquinone, p-methoxyphenol, di-t-butyl-p-cresol, pyrogallol, t-butylcatechol, benzoquinone, 4,4′-thiobis(3-methyl-6-t-butylphenol), 2,2′-methylenebis(4-methyl-6-t-butylphenol), and a cerium (I) salt of N-nitrosophenylhydroxylamine.

The addition amount of the thermal polymerization inhibitor is preferably in the range of 0.01 to 10 wt % relative to the total weight of the composition for laser engraving.

Furthermore in order to avoid polymerization inhibition due to oxygen, a higher fatty acid derivative, for example, behenic acid or behenic amide may be added and allowed to localize on the photosensitive layer surface during the drying step after the coating onto a support, etc., as necessary. The addition amount of the higher fatty acid derivative is preferably in the range of 0.5 to 15 wt % relative to the total weight of the composition for laser engraving.

### <Filler>

The filler may be an organic compound, an inorganic compound or a mixture thereof. Examples of the organic compound include carbon black, carbon nanotube, fullerene and graphite. Examples of the inorganic compound include silica, alumina, aluminum and calcium carbonate.

### <Plasticizer>

The plasticizer has the function of softening the composition for laser engraving and is required to be compatible with a binder polymer. Examples of the plasticizer include diethylene glycol, dioctyl phthalate, didodecyl phthalate, triethylene glycol dicaprate, dimethyl glycol phthalate, tricresyl phosphate, dioctyl adipate, dibutyl cebacate, and triacetylglycerin. The addition amount of the plasticizer is preferably not greater than 60 wt % relative to the total solids content by weight of the composition for laser engraving and more preferably not greater than 50 wt %.

### <Colorant>

Furthermore, a colorant such as dye and pigment may be added for the purpose of coloring the composition for laser engraving. By this addition, properties such as visibility of the image part or suitability for the image densitometer can be enhanced. As for the colorant, use of a pigment is particularly preferred. Specific examples of the colorant include pigments such as phthalocyanine-based pigment, azo-based pigment, and titanium oxide, and dyes such as Ethyl Violet, Crystal Violet, azo-based dye, anthraquinone-based dye and cyanine-based dye. The amount of the colorant added is preferably in the range of 0.5 to 10 wt % relative to the total weight of the resin composition for laser engraving.

### <Co-Sensitizer>

When a certain kind of additive (hereinafter, referred to as a co-sensitizer) is used, the sensitivity at the time of photocuring the composition for laser engraving can be further enhanced. The operating mechanism for this is not clearly understood, but it is believed to be largely based on a chemical process such as described below. That is, it is speculated that various intermediate active species (radicals and cations) generated in a photoreaction that is initiated by a photopolymerization initiator and a subsequent polymerization reaction, react with the co-sensitizer to produce new active radicals. These may be roughly classified into (i) species that can be reduced and thereby produce active radicals, (ii) species that can be oxidized and thereby produce active radicals, and (iii) species that react with less active radicals to be converted to radicals with higher activity or act as chain transfer agents. However, in many cases, there is no commonly accepted theory on which respective compounds belong to. Examples of the co-sensitizer that can be used in the present invention include trihalomethyl-s-triazines, trihalomethyloxadiazoles, diaryliodonium salts, triarylsulfonium salts, N-alkoxypyridinium (azinium) salts, alkylate complexes, alkylamine compounds, α-substituted methylcarbonyl compounds, 2-mercaptobenzothiazoles, 2-mercaptobenzoxazoles, and 2-mercaptobenzimidazoles. More specific examples of these co-sensitizers are described in, for example, JP-A-9-236913 as an additive intended to enhance sensitivity, and those such examples can also be applied to the present invention.

The co-sensitizer can be used individually, or two or more kinds can be used in combination. The use amount is preferably in the range of 0.05 part to 100 parts by weight, more preferably 1 part to 80 parts by weight, and even more preferably 3 parts to 50 parts by weight, relative to 100 parts by weight of the polymerizable compound.

### <Solvent>

In the present invention, a solvent used when preparing the composition for laser engraving is preferably mainly an aprotic organic solvent. More specifically, they are used preferably at aprotic organic solvent/protic organic solvent=100/0 to 50/50 (ratio by weight), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Furthermore, the amount of the solvent used is not particularly limited, but it is preferable to use the solvent such that the solids content amount in the composition for laser engraving is preferably 30 wt % to 95 wt %, more preferably 45 wt % to 90 wt %, and even more preferably 60 wt % to 88 wt %.

### (Oxygen Barrier Film)

Hereinafter, the oxygen barrier film used in the present invention will be described.

According to the present invention, the oxygen barrier film is such that the oxygen permeability at 25° C. and 1 atmosphere is preferably 30 ml/(m²-day·atm) or less, more preferably 10 ml/(m²·day·atm) or less, and particularly preferably 5 ml/(m²·day·atm) or less.

The oxygen permeability (ml/(m²·day·atm)) is measured in an environment at 25° C. and 60% RH using OX-TRAN2/21 manufactured by Mocon, Inc., according to the gas permeability testing method described in JIS-K7126B and ASTM-D3985.

The material of the oxygen barrier film is not particularly limited as long as it is a resin that satisfies a preferred embodiment of oxygen permeability, but preferred examples include resin films such as a polyvinyl chloride film, a polyvinyl fluoride film, a polyvinyl alcohol film, a polystyrene film, a polycarbonate film, a polyvinyl acetate film, a polyester film, a nylon film, a polyvinylidene chloride film, and a polyacrylonitrile film. More preferred examples include a polyester film, a nylon film, a polyvinylidene chloride film, and a polyacrylonitrile film, and a particularly preferred example is a polyvinylidene chloride film.

The thickness of the oxygen barrier film is dependent on the material of the oxygen barrier film, and if the oxygen barrier film is too thin, creases occur when the oxygen barrier film is laminated, and defective engraved surfaces are produced, while if the oxygen barrier film is too thick, handling is inconvenient, and the production cost increases. Therefore, the thickness is preferably 10 μm to 300 μm, and more preferably 50 μm to 200 μm.

### (Method for Producing Flexographic Printing Plate Precursor)

It is preferable that the process for producing a flexographic printing plate precursor of the present invention include, in the following order, forming a thermally curable layer containing component A and Component B; laminating an oxygen barrier film on the thermally curable layer; and thermally curing the thermally curable layer. Furthermore, it is preferable that the process further include applying an adhesive on the reverse surface of a surface that is in contact with the oxygen barrier film of the thermally curable layer, and bonding a support thereto (hereinafter, a support applying step). Meanwhile, the support applying step includes applying an adhesive on the reverse surface of a surface that is in contact with the oxygen barrier film of the thermally curable layer, and bonding a support thereto, and these two steps may be carried out almost simultaneously, or may be carried out in sequence. Furthermore, after an adhesive is applied on the support, the support may be bonded to the reverse surface of a surface that is in contact with the oxygen barrier film of the thermally curable layer.

Hereinafter, the configuration of the flexographic printing plate precursor will be described, and then various steps will be described.

### <Flexographic Printing Plate Precursor for Laser Engraving>

The “flexographic printing plate precursor for laser engraving” according to the present invention has a crosslinked relief-forming layer that is obtained by curing the relief-forming layer having thermally curable properties (thermally curable layer) comprising a composition for laser engraving by heat.

The “relief-forming layer” according to the present invention means a layer in a state before being thermally cured, that is, a layer comprising a composition for laser engraving of the present invention. The layer may be dried as necessary.

When a printing plate precursor having a crosslinked relief-forming layer is laser-engraved, the “flexographic printing plate” is produced.

The “crosslinked relief-forming layer” according to the present invention means a layer that has been crosslinked by thermally curing the relief-forming layer. The crosslinking described above is carried out under the action of heat. Furthermore, the crosslinking is not particular limited as long as it is a reaction that cures the composition for laser engraving, and an example of the crosslinking is a crosslinked structure formed by a polymerization reaction by Component A (a polymerizable compound), or a reaction between Component D (a compound having a hydrolyzable silyl group and/or a silanol group) and Component E (a binder polymer).

Furthermore, the “relief layer” according to the present invention means a layer that has been engraved by laser light in a flexographic printing plate, that is, the crosslinked relief-forming layer after laser engraving.

According to the present invention, the flexographic printing plate precursor for laser engraving has a relief-forming layer (thermally curable layer) comprising a composition for laser engraving containing the components such as described above. The (crosslinked) relief-forming layer is preferably provided on a support. Furthermore, an oxygen barrier film is laminated on the relief-forming layer. Furthermore, a protective film may also be provided, after the oxygen barrier film is peeled off.

The flexographic printing plate precursor for laser engraving may further have, if necessary, an adhesive layer between the support and the (crosslinked) relief-forming layer, or may have a slip coat layer between the (crosslinked) relief-forming layer and the oxygen barrier film, or between the crosslinked relief-forming layer and the protective film.

### <Relief-Forming Layer (Thermally Curable Layer)>

The relief-forming layer is a layer formed from the above-mentioned composition for laser engraving and is thermally crosslinkable.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

### <Support>

In the present invention, a material having flexibility and excellent dimensional stability is preferably used for the support, and examples thereof include a polyethylene terephthalate film (PET), a polyethylene naphthalate film (PEN), a polybutylene terephthalate film and a polycarbonate film. In view of mechanical properties, shape stability, handleability when making a printing plate and the like of the printing plate precursor, the thickness of the support is preferably 50 to 350 μm, more preferably 100 to 250 m. Also, in order to enhance the adhesion between the support and the relief-forming layer, a known adhesive conventionally used for such a purpose may be provided on the support surface, if desired.

Furthermore, the adhesive property to the relief-forming layer or adhesive layer can be enhanced by applying a physical or chemical treatment to the surface of the support for use in the present invention. Examples of the physical treatment include a sand blast method, a wet blast method of jetting a particle-containing liquid, a corona discharge treatment, a plasma treatment, and an ultraviolet ray or vacuum ultraviolet ray irradiation treatment. Examples of the chemical treatment include a strong acid or strong alkali treatment, an oxidant treatment, and a coupling agent treatment.

### <Adhesive Layer>

When a relief-forming layer is formed on a support, an adhesive layer may be provided between the relief-forming layer and the support for the purpose of strengthening the adhesion between the two layers.

Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in a surface of the relief-forming layer or the crosslinked relief-forming layer, a protection film may be provided on an outermost surface of the relief-forming layer or the crosslinked relief-forming layer, as necessary. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers.

The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin. Among them, from the viewpoint of tackiness, it is particularly preferable for a partially saponified polyvinyl alcohol having a degree of saponification of 60 to 99 mol %, or a hydroxyalkylcellulose or alkylcellulose with an alkyl group having 1 to 5 carbons to be used.

Hereinafter, the various steps of the process for producing a flexographic printing plate precursor will be described in detail.

### <Thermally Curable Layer Forming Step>

The formation of the thermally curable layer in the flexographic printing plate precursor for laser engraving is not particularly limited, but for example, a method of preparing a composition for laser engraving, removing the solvent from this composition for laser engraving as necessary, and then melt extruding the composition on a substrate such as an endless belt or a metal drum or on a support, may be used. Alternatively, a method of flow casting a composition for laser engraving on a substrate or a support, and removing the solvent from the composition for laser engraving by drying the substrate or support in an oven, may also be used.

According to the present invention, the method of molding the thermally curable layer into a sheet form or a cylindrical form may be carried out by using an existing resin molding method. For example, a casting method; a method of extruding a resin through a nozzle or a die using a machine such as a pump or an extruder, and adjusting the thickness with a blade or with calender processing using a roller may be listed as examples. At that time, molding can also be carried out while heating the resin to the extent that the performance of the resin is not deteriorated. Furthermore, the resin may also be subjected to a rolling treatment, a facing treatment, and the like as necessary. In many cases, the composition is molded on a support underlay called a back film, which comprises a material such as PET or nickel, but the resin may also be directly molded on the cylinder of a printing machine. Furthermore, a cylindrical substrate made of a fiber-reinforced plastic (FRP), a plastic, or a metal may also be used. In regard to the cylindrical substrate, a hollow cylindrical substrate having a certain thickness can be used for the purpose of reducing the weight. The role of the back film or the cylindrical substrate is to secure the dimensional stability of the printing plate precursor. Therefore, it is necessary to select one having high dimensional stability.

Specific examples of the material include a polyester resin, a polyimide resin, a polyamide resin, a polyamideimide resin, a polyether imide resin, a polybismaleimide resin, a polysulfone resin, a polycarbonate resin, a polyphenylene ether resin, a polyphenylene thioether resin, a polyether sulfone resin, a liquid crystal resin comprising a whole-aromatic polyester resin, a whole-aromatic polyamide resin, and an epoxy resin.

Furthermore, these resins can also be used as laminates. For example, a sheet formed by laminating a polyethylene terephthalate layer having a thickness of 50 μm on both surfaces of a whole-aromatic polyamide film having a thickness of 4.5 μm, may be used. Furthermore, a porous sheet, for example, a cloth formed by weaving a fiber, a non-woven fabric, a film in which fine pores have been formed, or the like can be used as the back film. In the case of using a porous sheet as the back film, when the composition for laser engraving is impregnated into the pores and then cured, high adhesiveness can be obtained because the relief-forming layer and the back film are integrated.

Examples of the fiber that forms the cloth or the non-woven fabric include inorganic fibers such as glass fiber, alumina fiber, carbon fiber, alumina-silica fiber, boron fiber, high silicon fiber, potassium titanate fiber, and sapphire fiber; natural fibers such as cotton fiber and jute fiber; semisynthetic fibers such as rayon fiber and acetate fiber; and synthetic fibers such as nylon fiber, polyester fiber, acrylic fiber, vinylon fiber, polyvinyl chloride fiber, polyolefin fiber, polyurethane fiber, polyimide fiber, and aramid fiber. Furthermore, cellulose that is produced by bacteria is a high-crystalline nanofiber, and is a material that can produce a thin non-woven fabric with high dimensional stability.

The thickness of the relief-forming layer (thermally curable layer) of the printing plate precursor for laser engraving may be arbitrarily set in accordance with the purpose of use, but when the relief-forming layer is used in a printing plate, the thickness is preferably in the range of from 0.05 mm to 10 mm. From the viewpoints of printing durability of the printing plate and the ease of laser engraving, the thickness is more preferably in the range of from 0.1 mm to 7 mm. In some cases, plural materials having different compositions may be laminated.

As the combination consisting of plural layers, for example, a layer that can be engraved by using a laser having an oscillation wavelength in the near-infrared region, such as a YAG laser, a fiber laser or a semiconductor laser, is formed on the outermost surface, and a layer that can be laser-engraved by using an infrared laser such as a carbon dioxide laser, or a visible/ultraviolet laser, can be formed underneath the outermost surface layer. When laser engraving is carried out by such a method, engraving can be carried out by using separate laser engraving apparatuses in which an infrared laser and a near-infrared laser are respectively mounted, or can also be carried out by using a laser engraving apparatuses in which both an infrared laser and a near-infrared laser are mounted.

### <Laminating Step>

The method of laminating an oxygen barrier film on the thermally curable layer is not particularly limited, but it is preferable to closely laminate the oxygen barrier film so that gas does not enter between the thermally curable layer and the oxygen barrier film.

A method of flow casting or applying the composition for laser engraving on the surface of a support (substrate) or a plate cylinder, subsequently laminating the oxygen barrier film thereon, and drying the assembly in an oven may be used, or a method of laminating a relief-forming layer on the oxygen barrier film, and then laminating a support may also be used, without any particular limitations.

Meanwhile, in the laminating step, an oxygen barrier film is laminated on one surface of the thermally curable layer, and a support (substrate) or a plate cylinder is present on the other surface, so that the thermally curable layer is interposed between the oxygen barrier film and the support (substrate) or the plate cylinder, and both the surfaces are blocked from oxygen supply.

### <Thermally Curing Step>

The process for producing a flexographic printing plate precursor for laser engraving of the present invention includes a thermal curing step of crosslinking the thermally curable layer by heating, and thereby obtaining a flexographic printing plate precursor having a crosslinked relief-forming layer.

Meanwhile, the thermally curing step is carried out in a state in which the thermally curable layer and the oxygen barrier film are laminated.

The thermally curable layer (relief-forming layer) can be cured (crosslinked) by heating (thermally curing step). As the heating means for carrying out curing under heat, a method of heating the printing plate precursor for a predetermined time in a hot air oven or a far-infrared oven, or a method of bringing the printing plate precursor into contact with a heated roll for a predetermined time may be used.

When the relief-forming layer is thermally crosslinked, there are advantages that first, the relief formed after laser engraving is rendered sharp, and secondly, the tackiness of the engraving residue generated at the time of laser engraving is suppressed.

### <Support Applying Step>

According to the present invention, it is preferable that the method include a step of applying an adhesive on the reverse surface of a surface that is in contact with the oxygen barrier film of the thermally curable layer, and bonding a support thereto (support applying step).

The support applying step may be carried out before the thermal curing step, or may be carried out after the thermal curing step; however, it is preferable to carry out the support applying step after the thermal curing step. When a thermally curable layer is formed on a substrate such as an endless belt, it is preferable that the method include the support applying step.

The adhesive used herein is not particularly limited, and examples include a photocurable adhesive, a thermally curable adhesive, and an anaerobic adhesive. Among these, a photocurable adhesive is preferred from the viewpoint of the ease of control of the curing reaction.

The photocurable adhesive may be either liquid or solid at room temperature (20° C.). When the photocurable adhesive is liquid at room temperature, the viscosity is preferably 100 Pa·s to 10 kPa·s, more preferably 500 Pa·s to 5 kPa·s, and even more preferably 1 kPa·s to 5 kPa·s. When the viscosity is in the range described above, it is preferable because liquid leakage is suppressed when the adhesive is applied.

Furthermore, when the photocurable adhesive is solid at room temperature, it is preferable to heat the photocurable adhesive to a softening temperature. Also, it is preferable to dissolve the photocurable adhesive in a solvent, apply the solution, and remove the solvent by drying; however, it is also acceptable to apply a solvent-free type hot melt photocurable adhesive in a heated state.

In the case of using a photocurable adhesive as the adhesive, it is preferable to use a transparent support. Since a transparent support has high light transmissivity, and light irradiation can be achieved through the support side in order to cure the photocurable adhesive, a curing reaction can be carried out with a low amount of irradiation.

### <Other Layers>

In the present invention, a cushion layer comprising a resin or rubber having cushion properties can be formed between the support and a film made of a resin (a layer other than the photosensitive layer), or between a film made of a resin and the (crosslinked) relief-forming layer. When a cushion layer is formed between the support and a resin film, a method of bonding a cushion layer having an adhesive layer attached on one surface, with the adhesive layer side directed toward the cylindrical support, is convenient. After the cushion layer is bonded, the surface may be shaped by cutting or polishing. A more convenient method is a method of forming the cushion layer by applying a liquid photocurable composition on a support to a certain thickness, and curing the composition using light. In order for the cushion layer to have cushion properties, it is preferable that the photocured product have low hardness. Furthermore, the cushion layer may include air bubbles. Also, it is possible to shape the surface of the cushion layer by cutting or polishing, and a cushion layer produced is useful as a seamless cushion layer.

### (Flexographic Printing Plate and a Method for Making the Same)

It is preferable that the method for making a flexographic printing plate according to the present invention include an engraving step of laser-engraving the flexographic printing plate precursor obtained by the production method of the present invention.

The flexographic printing plate is preferably a flexographic printing plate having a relief layer obtained by curing (crosslinking) and laser-engraving the thermally curable layer (relief-forming layer), and a flexographic printing plate made by the method for making a flexographic printing plate of the present invention.

### <Conditions for Laser Engraving>

In the laser engraving, a relief image is produced on a plate precursor by operating a laser apparatus using a computer by converting an image that is intended to form, into digitalized data.

As the laser used for laser engraving, any laser that includes the wavelength at which the plate precursor has absorption may be used. However, in order to perform engraving at a high speed, a laser having a high output power is preferred, and one preferred example is a laser having an oscillation wavelength in the infrared or near-infrared region, such as a carbon dioxide laser, a YAG laser, a semiconductor laser, or a fiber laser. Furthermore, an ultraviolet laser having an oscillation wavelength in the ultraviolet region, for example, an excimer laser, a YAG laser having its wavelength converted to a third or fourth harmonic wave, or a copper vapor laser, is capable of abrasion processing of cutting the bonds of organic molecules, and is suitable for microprocessing. A laser having a very high peak power, such as a femtosecond laser, can also be used. Further, the laser light may be irradiated in a continuous manner, or may be irradiated in a pulsatile manner.

Engraving using a laser is carried out in the presence of an oxygen-containing gas, and generally in the presence of air or under an air stream; however, engraving may also be carried out in the presence of carbon dioxide or nitrogen gas.

According to the present invention, the flexographic printing plate precursor for laser engraving or the flexographic printing plate can be used in various applications such as relief images for printing plates; design rolls for stamp processing or embossing processing; insulators and resistors used in the production of electronic components; relief images for the patterning of conductor pastes; relief images for frame materials of ceramic products; relief images for displays for advertisements, signboards and the like; and the prototypes and matrices of various molding products.

<Surface Treatment after Laser Engraving>

Furthermore, a reduction of tackiness of the printing plate surface, and an enhancement of ink wettability can also be achieved by forming a modifying layer on the relief surface of a cylindrical printing plate of the present invention on which an asperity pattern has been formed. The modifying layer may be a film treated with a compound which reacts with surface hydroxyl groups, such as a silane coupling agent or a titanium coupling agent; or a polymer film containing porous inorganic particles. Silane coupling agents that are used in a wide variety of applications are compounds having, in the molecule, functional groups which are highly reactive with the surface hydroxyl groups of a base material, and examples of such functional groups include a trimethoxysilyl group, a triethoxysilyl group, a trichlorosilyl group, a diethoxysilyl group, a dimethoxysilyl group, a dimonochlorosilyl group, a monoethoxysilyl group, a monomethoxysilyl group, and a monochlorosilyl group. Furthermore, at least one or more such functional groups are present in the molecule, and these functional groups are fixed to the base material surface by reacting with the surface hydroxyl groups of the base material. Furthermore, as the compound which constitutes a silane coupling agent, a compound having, in the molecule, at least one functional group selected from an acryloyl group, a methacryloyl group, an active hydrogen-containing amino group, an epoxy group, a vinyl group, a perfluoroalkyl group, and a mercapto group as a reactive functional group, or a compound having a long-chain alkyl group, can be used. When the coupling agent molecules fixed to the surface have polymerizable reactive groups in particular, a stronger film can be produced by crosslinking the coupling agent by irradiating the film with light, heat or an electron beam, after the fixation to the surface.

The surface treatment liquid is prepared by diluting the coupling agent described above, with a liquid mixture of water-alcohol or aqueous acetic acid-alcohol according to necessity. The concentration of the coupling agent in the treatment liquid is preferably 0.05 wt % to 10.0 wt %.

The method for treating with a coupling agent will be described. A treatment liquid containing the coupling agent described above is applied on the surface of a printing plate precursor, or the surface of a printing plate after laser engraving. There are no particular limitations on the method of applying a coupling agent treatment liquid, and for example, an immersion method, a spraying method, a roll coating method, a brush coating method or the like can be applied. Furthermore, there are also no particular limitations on the coating treatment temperature and the coating treatment time, but the coating treatment temperature is preferably from 5° C. to 60° C., while the treatment time is preferably from 0.1 seconds to 60 seconds. Further, it is preferable to perform drying of the treatment liquid layer on the surface of a resin plate under heating, and the heating temperature is preferably from 50° C. to 150° C.

The coupling agent can be fixed to the printing plate surface at a high density by producing hydroxyl groups by a method of irradiating light in the vacuum ultraviolet region with a wavelength of 200 nm or less using a xenon excimer lamp or the like, before the printing plate surface is treated with the coupling agent, or by exposing the printing plate surface to a high-energy atmosphere such as plasma.

Furthermore, when a layer containing inorganic porous particles is exposed at the printing plate surface, fine asperities can be formed at the printing plate surface by treating the printing plate surface in a high-energy atmosphere such as plasma, and slightly removing the organic layer of the surface by etching. Through this treatment, an effect of reducing tackiness of the printing plate surface, and an effect of enhancing ink wettability by making the inorganic porous particles exposed at the surface capable of easily absorbing ink, can also be expected.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the engraving step, since engraved residue is attached to the engraved surface, a rinsing step of washing off engraved residue by rinsing the engraved surface with water or a liquid comprising water as a main component may be added. Examples of rinsing means include a method of exposing to high pressure steam, a method in which washing is carried out with tap water; a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.2, and especially preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 wt % relative to the total weight of the rinsing liquid, and more preferably 0.05 to 10 wt %.

According to the present invention, a process for producing a flexographic printing plate precursor for laser engraving which has been improved in terms of low rise of the relief surface, curling over time, and adhesion of contaminants, and has excellent plate strength and excellent printing performance, may be provided.

### EXAMPLE

The present invention is explained in further detail below by reference to Examples, but the present invention should not be construed as being limited to these Examples. Furthermore, in the Examples and Comparative Examples below, ‘parts’ means ‘parts by weight’ and “%” means “% by weight”, unless otherwise specified.

The compounds of Component A to Component D used in the Examples and Comparative Examples will be listed below.

### (Component A: Polymerizable Compound)

A-1: Diethylene glycol dimethacrylate (manufactured by Shin-Nakamura Chemical Co., Ltd.)

A-2: Dipentaerythritol hexaacrylate (DPHA) (manufactured by Shin-Nakamura Chemical Co., Ltd.)

A-3: Tricyclodecanedimethanol dimethacrylate (DCP) (manufactured by Shin-Nakamura Chemical Co., Ltd.)

### (Component C: Photothermal Conversion Agent)

C-1: CARBON BLACK ASAHI #80 N-220 (DBP oil absorption amount: 113 ml/100 g, volume average particle size: 20 nm, manufactured by Asahi Carbon Co., Ltd.)

### (Component D: Compound Having Hydrolyzable Silyl Group or Silanol Group)

D-1: 3-Methacryloxypropyltriethoxysilane (KBE-503, manufactured by Shin-Etsu Chemical Co., Ltd.)

D-2: Bis(triethoxysilylpropyl)tetrasulfide (KBE-846, manufactured by Shin-Etsu Chemical Co., Ltd.)

D-3: Tris(3-trimethoxysilylpropyl)isocyanurate (X-12-965, manufactured by Shin-Etsu Chemical Co., Ltd.)

Films used as oxygen barrier films are shown below.

Polyester film (thickness: 100 μm): LUMIRA 100T F (manufactured by Fujifilm Corp.)

Polyester film (thickness: 50 μm): LUMIRA X42 (manufactured by Toray Industries, Inc.

Nylon film: SUPERNYL SP-R-P (manufactured by Mitsubishi Corp.)

Polyacrylonitrile film: ZEKROM (manufactured by Mitsui Chemicals, Inc.)

Polyvinylidene chloride film: SARAN WRAP (manufactured by Asahi Kasei Corp.)

### Examples 1 to 44 and Comparative Examples 1 to 14

### Method for Preparing Composition for Laser Engraving

40 parts by weight of DENKA BUTYRAL #3000-2 (manufactured by Denki Kagaku Kogyo K.K., Tg: 68° C.) was introduced into a three-necked flask equipped with a stirring spatula and a cooling tube, and 20 parts by weight of diethylene glycol as a plasticizer and 150 parts by weight of tetrahydrofuran as a solvent were introduced into the flask. The mixture was heated to 70° C. for 120 minutes under stirring to dissolve the binder polymer. To this binder polymer dispersion liquid, 0.005 parts by weight of PERBUTYL Z (t-butyl peroxybenzoate) (manufactured by NOF Corp.) as a polymerization initiator, 3 parts by weight of KBM802 (manufactured by Shin-Etsu Chemical Co., Ltd.) as a chain transfer agent, 5 parts by weight of (C-1) CARBON BLACK ASAHI #80 N-220, 0.5 parts by weight of 1,8-diazabicyclo[5.4.0]undec-7-ene (manufactured by Wako Pure Chemical Industries, Ltd.), and 15 parts by weight of (Component A) the polymerizable compound and 6 parts by weight of (Component D) the silane coupling agent (a compound having a hydrolyzable silyl group and/or a silanol group) indicated in the tables described below were added, and the mixture was stirred. Thus, compositions for laser engraving were obtained.

### <Production of Flexographic Printing Plate Precursor for Laser Engraving>

The composition for laser engraving was gently flow casted on a PET substrate (support) to the extent that the composition would not flow out, and an oxygen barrier film indicated in the following tables was bonded thereto such that air would not enter between the composition for laser engraving and the oxygen barrier film. The assembly was heated for 5 hours in an oven at 100° C., and the assembly was subjected to the removal of the solvent and thermal crosslinking. Subsequently, a relief layer was formed by laser engraving, and thereby, a flexographic printing plate was produced. Furthermore, hereinafter, the oxygen barrier film side in this case will be indicated as an oxygen barrier film surface, while the surface on the PET substrate side will be indicated as a PET surface.

### Examples 45 to 50 and Comparative Examples 15 to 17

### Method for Preparing Composition for Laser Engraving

40 parts by weight of DENKA BUTYRAL #3000-2 (manufactured by Denki Kagaku Kogyo K.K., Tg: 68° C.) was introduced into a three-necked flask equipped with a stirring spatula and a cooling tube, and 20 parts by weight of diethylene glycol as a plasticizer and 150 parts by weight of tetrahydrofuran as a solvent were introduced into the flask. The mixture was heated to 70° C. for 120 minutes under stirring to dissolve the binder. To this binder dispersion liquid, 0.005 parts by weight of PERBUTYL Z (t-butyl peroxybenzoate) (manufactured by NOF Corp.) as a polymerization initiator, 3 parts by weight of KBM802 (manufactured by Shin-Etsu Chemical Co., Ltd.) as a chain transfer agent, 5 parts by weight of (C-1) CARBON BLACK ASAHI #80 N-220, 6 parts by weight of (D-1) 3-methacryloxypropyltriethoxysilane, 0.5 parts by weight of 1,8-diazabicyclo[5.4.0]undeca-7-ene (manufactured by Wako Pure Chemical Industries, Ltd.), and 15 parts by weight of (Component A) the polymerizable compound indicated in the table described below were added, and the mixture was stirred. Thus, compositions for laser engraving were obtained.

### <Production of Flexographic Printing Plate Precursor for Laser Engraving>

The composition for laser engraving was gently flow casted on a PET substrate (support) to the extent that the composition would not flow out, and an oxygen barrier film indicated in the following Table 4 was bonded thereto such that air would not enter between the composition for laser engraving and the oxygen barrier film. The assembly was heated for 5 hours in an oven at 100° C., and the assembly was subjected to the removal of the solvent and thermal crosslinking, thereby a flexographic printing plate precursor was produced. Subsequently, the relief-forming layer and the support of this printing plate precursor were peeled off, and an acrylic ultraviolet-curable resin 3003 (manufactured by ThreeBond Co., Ltd.) was flow casted on the relief layer of the surface where the support had been peeled off. The detached support was bonded thereto such that air bubbles would not enter between the ultraviolet-curable resin and the support. The assembly was exposed under the conditions of 4 kW for 1 minute, using an EYE GRANDAGE (manufactured by Eye Graphics Co., Ltd.) as a UV exposure machine, and thus a flexographic printing plate precursor for laser engraving was produced. Furthermore, hereinafter, the oxygen barrier film side in this case will be indicated as an oxygen barrier film surface, while the surface on the PET substrate side will be indicated as a PET surface.

### (Method for Measurement and Evaluation)

### <Measurement of Oxygen Permeability>

The oxygen barrier films used were directly used as samples for measurement. The oxygen permeablity (ml/(m²·day·atm)) was measured in an environment at 25° C. and 60% RH using OX-TRAN2/21 manufactured by Mocon, Inc., according to the gas permeability testing method described in JIS-K7126B and ASTM-D3985.

### <Measurement of Tackiness (Measurement of Amount of Attached Paper)>

After the oxygen barrier film was detached, the weight of a flexographic printing plate precursor which measured 2 cm on each of the four sides was measured, and only the oxygen barrier film surface side of the plate was firmly pressed on 100% cellulose paper dust and fine pieces (manufactured by ZELATEX Japan Co., Ltd.) spread in a vat. Paper dust that was not adhering was shaken off, and then the weight of the flexographic printing plate precursor was measured to measure the weight of the adhering paper dust. A smaller weight of paper dust implies that the printing plate precursor has low tackiness, and contaminants do not easily adhere thereto. The weight of the adhering paper dust is indicated in the tables.

### <Measurement of Residue Scattering Properties>

The oxygen barrier film surface was engraved using a carbon dioxide laser engraving machine, “HELIOS 6010” (manufactured by Stork Prints BV). The oxygen barrier film was detached, and PET was placed on the rotational trajectory of the engraved plate that had been attached to a drum. Liquid engraving residue that had been scattered away by the centrifugal force was collected, and the liquid droplet area of the liquid engraving residue adhered to PET was measured. The liquid droplet areas measured are indicated in the following tables. A solid section which measured 4 cm on each of four sides was engraved, while the engraving conditions were set at a laser output power of 500 W, a number of drum rotation of 800 cm/sec, and a relief depth of 0.30 mm.

### <Measurement of Plate Strength>

The plate strength was determined by die cutting a solid part into an hourglass shape, and then measuring the weight per unit area (N/mm²) needed to fracture the plate, using a load testing machine “FGS-100TV” manufactured by NIDEC-SHIMPO Corp. The load needed to fracture Comparative Example 1 was designated as 100, and the plate strength of other plates was calculated. As this value of plate strength is larger, it means superior in plate strength. The results will be described in the tables given below.

### <Measurement of Curling (Measurement of Lift Height)>

A flexographic printing plate was die cut to a size of 2 cm×6 cm, and was left to stand for 120 hours in an oven at 40° C. Subsequently, the distances between the four corners of the plate precursor and the horizontal platform were measured. The results are described in the tables shown below.

<Measurement of Low-Rise (Measurement of Distance of Low-Rise from Solid Section)>

A flexographic printing plate precursor from which the oxygen barrier film had been detached was subjected to halftone dot engraving using a carbon dioxide laser engraving machine, and then the cross-section of a solid engraved section was observed with a confocal color 3-D profile measuring microscope VK9510 (manufactured by Keyence Corp.) to measure the difference between the height of the vertices of halftone dots and the height of unengraved area was measured. 10% halftone dots having a width of the vertex of a halftone dot of 10 μm were engraved.

As the carbon dioxide laser engraving machine, “HELIOS 6010 (manufactured by Stork Prints BV) was used. A solid section which measured 4 cm on each of four sides was engraved, while the engraving conditions were set at a laser output power of 500 W, a speed of drum rotation of 800 cm/sec, and a relief depth of 0.15 mm. The results will be indicated in the tables shown below.

### <Measurement of Dot Gain>

The position at which a plate that had been subjected to 20% halftone dot engraving with a width of the vertex of a halftone dot of 10 μm kiss-touches a print material was designated as a zero-point position, and printing was performed in a state in which the printing plate precursor was firmly pressed up to 40 μm in the direction of print material (hereinafter, indicated as standard pressure) and in a state in which the printing plate precursor was firmly pressed up to 100 μm (hereinafter, indicated as forced pressure). The cyan reflection density of the ink that was transferred to the print material was measured. The values of [cyan reflection density at the time of forced pressure]/[cyan reflection density at the time of standard pressure] are described in the tables shown below. As the value of [cyan reflection density at the time of forced pressure]/[cyan reflection density at the time of standard pressure] approaches 1, there is no dot gain, and excellent printing performance is exhibited.

A flexographic printing plate precursor was subjected to 20% halftone dot engraving, with the width of the vertex of a halftone dot being 10 μm, using “HELIOS 6010” (manufactured by Stork Prints BV) as a carbon dioxide laser engraving machine, and then the engraving residue was washed off with water. Printing was performed on AURORA coated paper manufactured by Nippon Paper Industries Co., Ltd., using UV FLEXO 500 manufactured by T&K Toka Corp. as a UV ink. The cyan reflection density of the print material was measured using SPECTROEYE manufactured by GretagMacbeth, Ltd.

The engraving conditions were set to a laser output power of 500 W, a speed of drum rotation of 800 cm/second, and a relief depth of 0.30 mm.

### <Measurement of Peeling Force>

The peeling force was determined by detaching the oxygen barrier film, subsequently cutting the printing plate precursor into a size of 2 cm×6 cm, and measuring the load per unit width (N/cm) needed to detach the printing plate precursor and the adhesive layer, using a load testing machine “FGS-100TV” manufactured by NIDEC-SHIMPO Corp. The load needed to fracture Comparative Example 15 was designated as 100, and the peeling force for other plates was calculated relative thereto. The peeling force represents the force needed to detach the plate precursor part of a laminated plate and the adhesive layer, and a larger peeling force means that the adhesive layer and the plate precursor are not easily detached, and the plate can withstand printing for a long time. The results are described in the following Table 4.

TABLE 1

| | | | | | | | | Area of | | | | |
|---|---|---|---|---|---|---|---|---|---|---|---|---|
| | | | | | | | Amount | residue | | | | |
| | | | | | | | of | scattering | | | Distance | |
| | | | | | Film | Oxygen | attached | (residue | | | of low- | |
| | Sample type | | | | thick- | permeability | paper | scattering | | Lift | rise from | |
| Example | Compo- | Compo- | Compo- | | ness | (ml/(m² · | dust | properties) | Plate | height | solid area | Dot |
| No. | nent A | nent C | nent D | Oxygen barrier film | (μm) | day · atm)) | (g/m²) | (cm²) | strength | (mm) | (μm) | gain |
| 1 | A-1 | None | None | Polyester | 100 | 20 | 20 | 14 | 140 | 12 | 37 | 1.32 |
| 2 | A-1 | None | None | Polyacrylonitrile | 30 | 10 | 15 | 12 | 160 | 10 | 35 | 1.30 |
| 3 | A-1 | None | None | Nylon | 18 | 8 | 13 | 11 | 180 | 9 | 34 | 1.29 |
| 4 | A-1 | None | None | Polyvinylidene chloride | 11 | 1 | 10 | 10 | 185 | 9 | 33 | 1.28 |
| 5 | A-2 | None | None | Polyester | 100 | 20 | 18 | 12 | 143 | 11 | 36 | 1.31 |
| 6 | A-2 | None | None | Polyacrylonitrile | 30 | 10 | 15 | 10 | 163 | 9 | 34 | 1.29 |
| 7 | A-2 | None | None | Nylon | 18 | 8 | 13 | 9 | 200 | 8 | 33 | 1.28 |
| 8 | A-2 | None | None | Polyvinylidene chloride | 11 | 1 | 9 | 8 | 205 | 7 | 32 | 1.28 |
| 9 | A-3 | None | None | Polyester | 100 | 20 | 15 | 10 | 150 | 8 | 33 | 1.28 |
| 10 | A-3 | None | None | Polyacrylonitrile | 30 | 10 | 13 | 8 | 172 | 6 | 31 | 1.26 |
| 11 | A-3 | None | None | Nylon | 18 | 8 | 10 | 7 | 188 | 5 | 30 | 1.25 |
| 12 | A-3 | None | None | Polyvinylidene chloride | 11 | 1 | 6 | 6 | 192 | 5 | 30 | 1.24 |
| 13 | A-1 | C-1 | None | Polyester | 100 | 20 | 13 | 10 | 152 | 11 | 30 | 1.30 |
| 14 | A-1 | C-1 | None | Polyacrylonitrile | 30 | 10 | 10 | 8 | 171 | 9 | 28 | 1.28 |
| 15 | A-1 | C-1 | None | Nylon | 18 | 8 | 8 | 5 | 193 | 8 | 27 | 1.28 |
| 16 | A-1 | C-1 | None | Polyvinylidene chloride | 11 | 1 | 5 | 4 | 198 | 8 | 27 | 1.27 |
| 17 | A-2 | C-1 | None | Polyester | 100 | 20 | 10 | 9 | 156 | 10 | 29 | 1.29 |
| 18 | A-2 | C-1 | None | Polyacrylonitrile | 30 | 10 | 8 | 7 | 174 | 8 | 27 | 1.28 |
| 19 | A-2 | C-1 | None | Nylon | 18 | 8 | 6 | 5 | 197 | 7 | 26 | 1.27 |
| 20 | A-2 | C-1 | None | Polyvinylidene chloride | 11 | 1 | 4 | 5 | 200 | 5 | 25 | 1.27 |
| 21 | A-3 | C-1 | None | Polyester | 100 | 20 | 7 | 7 | 165 | 8 | 27 | 1.28 |
| 22 | A-3 | C-1 | None | Polyacrylonitrile | 30 | 10 | 5 | 6 | 183 | 6 | 25 | 1.27 |

TABLE 2

| | | | | | | | | Area of | | | | |
|---|---|---|---|---|---|---|---|---|---|---|---|---|
| | | | | | | | Amount | residue | | | | |
| | | | | | | | of | scattering | | | Distance | |
| | | | | | Film | Oxygen | attached | (residue | | | of low- | |
| | Sample type | | | | thick- | permeability | paper | scattering | | Lift | rise from | |
| Example | Compo- | Compo- | Compo- | | ness | (ml/(m² · | dust | properties) | Plate | height | solid area | Dot |
| No. | nent A | nent C | nent D | Oxygen barrier film | (μm) | day · atm)) | (g/m²) | (cm²) | strength | (mm) | (μm) | gain |
| 23 | A-3 | C-1 | None | Nylon | 18 | 8 | 3 | 4 | 202 | 5 | 24 | 1.27 |
| 24 | A-3 | C-1 | None | Polyvinylidene chloride | 11 | 1 | 3 | 4 | 205 | 4 | 24 | 1.25 |
| 25 | A-1 | C-1 | D-1 | Polyester | 100 | 20 | 11 | 6 | 160 | 6 | 26 | 1.27 |
| 26 | A-1 | C-1 | D-1 | Polyacrylonitrile | 30 | 10 | 7 | 4 | 180 | 3 | 24 | 1.26 |
| 27 | A-1 | C-1 | D-1 | Nylon | 18 | 8 | 5 | 3 | 200 | 2 | 23 | 1.24 |
| 28 | A-1 | C-1 | D-1 | Polyvinylidene chloride | 11 | 1 | 3 | 3 | 205 | 2 | 19 | 1.23 |
| 29 | A-1 | C-1 | D-2 | Polyester | 100 | 20 | 10 | 6 | 165 | 6 | 25 | 1.26 |
| 30 | A-1 | C-1 | D-2 | Polyacrylonitrile | 30 | 10 | 6 | 5 | 180 | 3 | 22 | 1.24 |
| 31 | A-1 | C-1 | D-2 | Nylon | 18 | 8 | 5 | 3 | 205 | 2 | 20 | 1.23 |
| 32 | A-1 | C-1 | D-2 | Polyvinylidene chloride | 11 | 1 | 2 | 3 | 210 | 2 | 18 | 1.21 |
| 33 | A-1 | C-1 | D-3 | Polyester | 100 | 20 | 8 | 4 | 175 | 4 | 21 | 1.24 |
| 34 | A-1 | C-1 | D-3 | Polyacrylonitrile | 30 | 10 | 5 | 3 | 190 | 3 | 19 | 1.22 |
| 35 | A-1 | C-1 | D-3 | Nylon | 18 | 8 | 4 | 2 | 215 | 2 | 17 | 1.20 |
| 36 | A-1 | C-1 | D-3 | Polyvinylidene chloride | 11 | 1 | 2 | 2 | 220 | 2 | 15 | 1.19 |
| 37 | A-2 | C-1 | D-3 | Polyester | 100 | 20 | 7 | 3 | 180 | 5 | 19 | 1.17 |
| 38 | A-2 | C-1 | D-3 | Polyacrylonitrile | 30 | 10 | 4 | 2 | 200 | 3 | 17 | 1.15 |
| 39 | A-2 | C-1 | D-3 | Nylon | 18 | 8 | 3 | 2 | 220 | 2 | 15 | 1.14 |
| 40 | A-2 | C-1 | D-3 | Polyvinylidene chloride | 11 | 1 | 2 | 2 | 225 | 2 | 10 | 1.13 |
| 41 | A-3 | C-1 | D-3 | Polyester | 100 | 20 | 5 | 2 | 190 | 4 | 12 | 1.15 |
| 42 | A-3 | C-1 | D-3 | Polyacrylonitrile | 30 | 10 | 3 | 2 | 215 | 3 | 10 | 1.14 |
| 43 | A-3 | C-1 | D-3 | Nylon | 18 | 8 | 2 | 2 | 230 | 0 | 7 | 1.12 |
| 44 | A-3 | C-1 | D-3 | Polyvinylidene chloride | 11 | 1 | 1 | 1 | 233 | 0 | 5 | 1.11 |

TABLE 3

| | | | | | | Oxygen | Amount of | Area of residue | | | Distance | |
|---|---|---|---|---|---|---|---|---|---|---|---|---|
| Compp. | Sample type | | | Oxygen | Film | permeability | attached | scattering (residue | | Lift | of low-rise | |
| Example | Compo- | Compo- | Compo- | barrier | thickness | (ml/(m² · | paper dust | scattering | Plate | height | from solid | Dot |
| No. | nent A | nent C | nent D | film | (μm) | day · atm)) | (g/m²) | properties) (cm²) | strength | (mm) | area (μm) | gain |
| 1 | A-1 | None | None | None | None | None | 67 | 40 | 100 | 18 | 75 | 1.50 |
| 2 | A-2 | None | None | None | None | None | 62 | 38 | 103 | 19 | 73 | 1.49 |
| 3 | A-3 | None | None | None | None | None | 57 | 34 | 110 | 21 | 70 | 1.47 |
| 4 | A-1 | C-1 | None | None | None | None | 47 | 36 | 113 | 19 | 68 | 1.48 |
| 5 | A-2 | C-1 | None | None | None | None | 44 | 34 | 116 | 20 | 66 | 1.46 |
| 6 | A-3 | C-1 | None | None | None | None | 42 | 30 | 121 | 21 | 63 | 1.45 |
| 7 | A-3 | C-1 | None | Polyester | 50 | 38 | 39 | 28 | 125 | 15 | 54 | 1.41 |
| 8 | A-1 | C-1 | D-1 | None | None | None | 45 | 34 | 120 | 20 | 65 | 1.47 |
| 9 | A-1 | C-1 | D-2 | None | None | None | 43 | 32 | 123 | 21 | 62 | 1.46 |
| 10 | A-1 | C-1 | D-3 | None | None | None | 42 | 30 | 126 | 22 | 60 | 1.46 |
| 11 | A-1 | C-1 | D-3 | Polyester | 50 | 38 | 37 | 27 | 130 | 16 | 48 | 1.39 |
| 12 | A-2 | C-1 | D-3 | None | None | None | 34 | 29 | 128 | 23 | 60 | 1.45 |
| 13 | A-3 | C-1 | D-3 | None | None | None | 28 | 25 | 131 | 25 | 57 | 1.43 |
| 14 | A-3 | C-1 | D-3 | Polyester | 50 | 38 | 24 | 22 | 135 | 20 | 43 | 1.37 |

TABLE 4

| | | | | Oxygen | Amount of | Area of residue | | Distance | | |
|---|---|---|---|---|---|---|---|---|---|---|
| | | | Film | permeability | attached | scattering (residue | Lift | of low-rise | | |
| Example | Sample type | Oxygen barrier | thickness | (ml/(m² · | paper dust | scattering properties) | height | from solid | Dot | Peeling |
| No. | Component A | film | (μm) | day · atm)) | (g/m²) | (cm²) | (mm) | area (μm) | gain | force |
| Ex. 45 | A-1 | Polyester | 100 | 20 | 11 | 6 | 6 | 26 | 1.27 | 130 |
| Ex. 46 | A-1 | Polyacrylonitrile | 30 | 10 | 7 | 4 | 3 | 24 | 1.26 | 133 |
| Ex. 47 | A-1 | Nylon | 18 | 8 | 5 | 3 | 2 | 23 | 1.24 | 137 |
| Ex. 48 | A-1 | Polyvinylidene | 11 | 1 | 3 | 3 | 2 | 19 | 1.23 | 140 |
| | | chloride | | | | | | | | |
| Ex. 49 | A-2 | Polyester | 100 | 20 | 11 | 6 | 6 | 25 | 1.27 | 135 |
| Ex. 50 | A-3 | Polyester | 100 | 20 | 7 | 4 | 4 | 23 | 1.25 | 139 |
| Comp. | A-1 | None | None | None | 45 | 34 | 21 | 65 | 1.47 | 100 |
| Ex. 15 | | | | | | | | | | |
| Comp. | A-2 | None | None | None | 40 | 32 | 23 | 63 | 1.45 | 102 |
| Ex. 16 | | | | | | | | | | |
| Comp. | A-3 | None | None | None | 35 | 30 | 24 | 60 | 1.44 | 108 |
| Ex. 17 | | | | | | | | | | |

From the results of the tables shown above, it was confirmed that a flexographic printing plate precursor for laser engraving produced by a production method involving laminating a thermally curable layer containing a thermal polymerization initiator and a polymerizable compound, with an oxygen barrier film having an oxygen permeability at 25° C. and 1 atmosphere of 30 ml/(m²·day·atm) or less, and thermally curing the thermally curable layer, can reduce the low-rise of the relief surface, curling over time, adhesion of contaminants, and viscousness of the oxygen barrier film surface, and can have excellent plate strength and printing performance. Furthermore, it was confirmed that the low-rise can be reduced, so that the highlights (shade) of the images produced by transferring ink to an object to be printed is satisfactory, while highlights are insufficient in the Comparative Examples.

Furthermore, when the adhesive layer and the plate precursor are detached, it is necessary to exchange the plate; however, since the adhesive layer and the plate precursor are not easily detached, the horizontal displacement of the plate at the time of printing can be suppressed. Also, printing durability was enhanced.

In addition, when platemaking is carried out by a method of flow casting a coating liquid on a support, a decrease in the thickness of edge areas occurs due to hot flow. Thus, when a printing plate is made, those areas with small thicknesses need to be cut out, and there was a waste. In the present invention, it was found that when an oxygen barrier film is bonded, hot flow can be suppressed, and a decrease in the thickness of edge areas is suppressed. This is thought to be because hot flow of the thermally curable composition is avoided by the surface tension of the oxygen barrier film, but the cause is not clearly understood.

What is claimed is:

1. A process for producing a flexographic printing plate precursor for laser engraving, the method comprising, in the following order:
a thermally curable layer-forming step of forming a thermally curable layer containing (Component A) a polymerizable compound and (Component B) a thermal polymerization initiator;
a laminating step of laminating an oxygen barrier film having an oxygen permeability at 25° C. and 1 atmosphere of 30 ml/(m²·day·atm) or less, on the thermally curable layer; and
a thermally curing step of thermally curing the thermally curable layer.

2. The process for producing a flexographic printing plate precursor for laser engraving according to claim 1, wherein the oxygen barrier film is at least one selected from the group consisting of a polyester film, a nylon film, a polyethylene terephthalate film, a polyvinylidene chloride film, and a polyacrylonitrile film.

3. The process for producing a flexographic printing plate precursor for laser engraving according to claim 1, wherein the thickness of the oxygen barrier film is 10 μm to 300 μm.

4. The process for producing a flexographic printing plate precursor for laser engraving according to claim 1, wherein (Component A) the polymerizable compound is a compound having two or more terminal ethylenically unsaturated bonds in one molecule.

5. The process for producing a flexographic printing plate precursor for laser engraving according to claim 1, wherein the thermally curable layer contains (Component A) the polymerizable compound in an amount of 5 wt % to 30 wt % relative to the total solids content.

6. The process for producing a flexographic printing plate precursor for laser engraving according to claim 1, wherein (Component B) is selected from the group consisting of organic peroxides and azo compounds.

7. The process for producing a flexographic printing plate precursor for laser engraving according to claim 1, wherein the thermally curable layer further comprises (Component C) a photothermal conversion agent.

8. The process for producing a flexographic printing plate precursor for laser engraving according to claim 7, wherein (Component C) the photothermal conversion agent is carbon black.

9. The process for producing a flexographic printing plate precursor for laser engraving according to claim 1, wherein the thermally curable layer further comprises (Component D) a compound having a hydrolyzable silyl group and/or a silanol group.

10. The process for producing a flexographic printing plate precursor for laser engraving according to claim 1, wherein the thermally curable layer further comprises (Component E) a binder polymer.

11. The process for producing a flexographic printing plate precursor for laser engraving according to claim 10, wherein (Component E) the binder polymer is a non-elastomeric binder.

12. The process for producing a flexographic printing plate precursor for laser engraving according to claim 11, wherein (Component E) the binder polymer is polyvinyl acetal or a derivative thereof.

13. The process for producing a flexographic printing plate precursor for laser engraving according to claim 1, further comprising a step of applying an adhesive on the reverse surface of a surface that is in contact with the oxygen barrier film of the thermally curable layer, and bonding a support thereto.

14. The process for producing a flexographic printing plate precursor for laser engraving according to claim 13, wherein the adhesive is a photocurable adhesive, and the thermally curable layer and the support are adhered by curing the photocurable adhesive by light.

15. The process for producing a flexographic printing plate precursor for laser engraving according to claim 14, wherein the support is a transparent support.

16. The process for producing a flexographic printing plate precursor for laser engraving according to claim 2, wherein the thickness of the oxygen barrier film is 10 μm to 300 μm.

17. The process for producing a flexographic printing plate precursor for laser engraving according to claim 2, wherein the thermally curable layer further comprises (Component D) a compound having a hydrolyzable silyl group and/or a silanol group.

18. The process for producing a flexographic printing plate precursor for laser engraving according to claim 3, wherein the thermally curable layer further comprises (Component D) a compound having a hydrolyzable silyl group and/or a silanol group.

19. The process for producing a flexographic printing plate precursor for laser engraving according to claim 16, wherein the thermally curable layer further comprises (Component D) a compound having a hydrolyzable silyl group and/or a silanol group.
